(19) United States
(12) Patent Application Publication
(10) Pub. No.: US 2026/0067417 A1
(43) Pub. Date: Mar. 5, 2026

(54) MOBILE ENTERTAINMENT PRODUCTION CONTROL SYSTEM

(71) Applicant: TPS at Fort Mac, LLC, Atlanta, GA (US)

(72) Inventors: Tyler Perry, Atlanta, GA (US); David Strupp, Atlanta, GA (US)

(21) Appl. No.: 19/312,834

(22) Filed: Aug. 28, 2025

Related U.S. Application Data
(60) Provisional application No. 63/688,457, filed on Aug. 29, 2024.

(51) Int. Cl. H04N 5/28; H04W 4/029

(52) U.S. Cl. CPC H04N 5/28; H04W 4/029

(57) ABSTRACT

A mobile entertainment production control system including a tow vehicle and a mobile production command or control center for enabling enhanced efficiencies in the production of entertainment content such as movies, television programming, and the like. The mobile control command or control center can include a trailer including a series of production suites or positions and an on-board power system configured to provide power to the mobile production command or control center, which can provide support for a series of mobile production assemblies configured to receive and record inputs of video, sound, and other data, as well as enable wireless communications and playback of video, and which can be configured to transfer video and audio data to the mobile production command or control center. Communication with the mobile production command or control center and control of aspects of the filming operation can be directed using a mobile control application.

### CROSS-REFERENCE TO RELATED APPLICATION

The present application claims benefit of co-pending U.S. Provisional Patent Application No. 63/688,457, filed Aug. 29, 2024.

### INCORPORATED BY REFERENCE

The disclosure of U.S. Provisional Patent Application No. 63/688,457, filed Aug. 29, 2024, is incorporated by reference herein for all purposes as if set forth in its entirety.

### FIELD OF THE INVENTION

The present disclosure relates generally to systems, apparatus, and methods in the field of entertainment productions, and, more particularly, to various aspects involving systems, apparatus and methods to a mobile entertainment production control system for the production of entertainment content, such as television programs, movies, and other content.

### BACKGROUND

The production of entertainment content such as movies, television or television programs, radio programs, news and other entertainment content has been in a constant state of expansion since its inception. The advent of cable TV and more recently services in addition to traditional network TV and movie theater experiences, consumers not only have what to watch or listen to, they also come to demand much more variety in the programs they choose. Streaming services such as Amazon, Netflix, Hulu Disney, and other services come in addition to traditional network television programming and movie studios are now looking to create more original content to meet the ever-growing entertainment programming. However, as the demand for more entertainment content has increased, so has the complexity and cost of production. For example, production systems including digital imaging tech (DIT), video tape recording (VTR) and audio or sound recording operations are all generally necessary for the production/filming of scenes for movies and television shows. In addition to the set-up of production equipment such as cameras, sound recording equipment, power, lighting, connecting feeds for monitors, etc., individual workstations generally have had to be established for collection of recorded video and audio, which thereafter generally has had to be transferred to the studio for processing. Such operations can require substantial additional time, expense and labor, for example, to transport and set-up audio and video workstations at a filming location, and thereafter break them down for transport to a next filming location, and can delay production. This can be further exacerbated when filming scenes at remote locations far away from a studio or production lot.

Accordingly, it can be seen that a need exists for systems and methods for the production of entertainment content such as movies, television, news, radio, and other programs that addresses the foregoing and other related and unrelated problems in the art.

### SUMMARY

Briefly described, the present disclosure generally relates to systems and methods for the enhancing the efficiency and quality of the production of entertainment content, such as television programs, movies, news programs and other content or programing. In embodiments, the systems of the present disclosure can comprise a mobile entertainment production control system configured to function as an independent, self-contained production facility with in-studio processing capabilities/functionalities to enable substantially real-time processing of recorded entertainment programming/content on-site or at a shooting location, including remote locations.

In embodiments, the mobile entertainment production control system can include a mobile production control center having a modular construction that can comprise a plurality of production suites or bays including workstations or positions adapted to perform various production tasks, such as monitoring and copying of digital video cards, a digital imaging tech suite (DIT), file based recording (VTR) and processing and coloring of video, audio/sound recording and processing, and/or for other production tasks.

In embodiments, the mobile entertainment production control system further can include a modular system of positions or workstations that, in embodiments, can include modules or components that can be combined and transported together as part of a mobile platform to a filming location to facilitate rapid establishment of production operations at a filming location in an easy and more efficient manner, while also enabling the disconnection and movement of such production systems and equipment to different locations with substantially increased speed and efficiency. As a result, creation of the overall entertainment production (e.g., movies, TV shows, etc.) can be conducted in a more streamlined fashion, enabling better control of the costs and time required for the production (e.g., enabling the production to be completed in less time and with greater continuity of the overall filming operation).

In embodiments, the mobile production control system can include a tow vehicle and a mobile production command or control center that can be connected to the tow vehicle for transport to a filming location. In addition, in some embodiments, a transport vehicle also can be provided for moving and/or transport of production equipment, and in embodiments, transporting the mobile production command or control center on-site. In embodiments, the mobile production command or control center can comprise a trailer. In embodiments, the trailer include a frame or chassis with trailer body supported thereon.

In embodiments, the trailer body of the mobile production command or control center generally will include a plurality of production suites or bays defined therein. In embodiments, the production suites or bays can be configured for performing the various production functions, operations, or tasks such as processing of video and sound on site during the filming of scenes and can be operated as a substantially self-sufficient entertainment production control center even at remote filming location(s). In embodiments, the trailer can be reconfigured for more or less production suites or bays, and in some embodiments, can be configured to connect in series to other trailers to provide further production suites or bays and processing operations.

In exemplary embodiments, the production suites or bays of the mobile production command or control center can include a first suite or position, e.g., a DIT production suite, a second suite or position, e.g., a VTR suite, third suite or position, e.g., an audio or sound recording suite and a fourth suite or position for monitoring and copying of video footage from digital cards/recordings, e.g., a “Loader” suite or position. It is contemplated that other production suites can also be provided. In embodiments, the number of bays or suites and the sizes and configurations each individual bay or suite can be varied. For example, in various optional embodiments, the mobile production command or control center can be configured with at least 3 production bays or suites, with at least 4 production bays or suites; with at least 5 production bays or suites, and, in one example, with 3-5 production bays or suites. Various workstations can be provided in each production bay or suite, which workstations further can be configured for performing specific production tasks.

In embodiments, the mobile production command or control center can be configured to receive power from the tow vehicle while on-site, and can further receive data, such as digital video and audio wirelessly, through direct wired connections, or a combination thereof, from on-site production equipment, such as microphones, lighting, sound recording systems, color-correction, record and playback and audio recording equipment, mobile production assemblies, etc. In exemplary aspects, the mobile production command or control center further can be disconnected from the tow vehicle and connected to an external power source or an on-board power source.

In embodiments, the tow vehicle can comprise a truck or other vehicle having a sufficient towing capacity for towing the mobile production command or control center to a variety of locations, including remote locations with uneven terrain and/or limited access. The tow vehicle can have a selected cargo capacity; for example, in embodiments, the tow vehicle can include an enclosed cargo area configured to store and enable access and quick loading and off-loading of various production equipment or components. In embodiments, the tow vehicle generally will be designed as a purpose built vehicle that acts as a companion to the trailer to provide power and supporting equipment such as the cabling.

In optional embodiments, the tow vehicle also can include a lift gate, ramps, fold out doors or other features to enable easy loading and unloading. Further, the tow vehicle can also include a tow hitch for coupling the mobile production center thereto. In embodiments, the tow hitch can exemplarily include power and data line connections for transfer of power from the tow vehicle to the mobile production center to power the operations thereof.

In some embodiments, the cargo area of the tow vehicle can be configured with a power supply system that can include a series of batteries or power storage units and can have an integrated power connection or junction linked to the batteries and which can be accessible from outside the cargo area of the tow vehicle. In embodiments, the tow vehicle also can have connections for external power and/or data, (e.g., for connection to external power sources). In optional embodiments, the power supply system can be configured to supply a sufficient amount of power to the mobile production command or control center for operation thereof for at least one full day, and, in some embodiments, up to 2-3 full days. Additional power supply units also can be provided to further increase the power supply capacity of the power system. In some embodiments, multiple tow vehicles can be provided.

In embodiments, the power connection or junction of the tow vehicle can include power and data input connections and output connections to enable the tow vehicle to act as an on-site power source for the on-set production equipment and the production systems of the mobile production command or control center (e.g., DIT, VTR, sound recording and editing, loading and copying of digital video cards/recordings, and the like) during filming and for collection and transmission of data as needed, as well as for connection of the series of batteries of the tow vehicle to an external power source as needed for charging the batteries. In optional embodiments, the tow vehicle further can include solar panels positioned on the roof of the tow vehicle that can be conventionally connected to inverters and the on-board series of batteries for supplying power thereto.

Optionally, the mobile command or control production center also can include at least one transport vehicle that can be used to move selected production equipment to set up another geographically spaced production site. For example, each production department (e.g., cameras, audio, grip, etc.) can have its own transport vehicle. The mobile production control system thus can enable a leapfrog effect in entertainment production operations to increase efficiency and productivity in the set-up, filming and production of scenes. In embodiments, the transport vehicle, such as a box truck or similar vehicle, can be provided for transport of desired production equipment. In embodiments, the transport vehicle also can include a lift gate, ramps, fold out doors or other features to enable easy loading and unloading. In some embodiments, the transport vehicle also could be used as an additional power source for the mobile production command or control center, various production systems and/or equipment, or combinations thereof. Still further, in embodiments, a transport vehicle can be used to transport the mobile production command or control center to a site, and one or more transport vehicles further can include at least a portion of the functionality of the tow vehicle.

In embodiments, once external power for the mobile production command or control center production systems and other on-set production equipment has been established, the transport vehicle can be disconnected and used for the transport and set-up of additional production equipment at other locations. In this aspect, it is contemplated that the mobile production command or control center can be left as an on-set or on-location free-standing production control center while the transport vehicle (and in some embodiments, a secondary trailer that can be coupled thereto) can move to another set location for set-up and readying production/filming of a next scene or scenes. This process can be repeated iteratively (i.e., in a “leapfrog” operation) and thereby enables filming to begin almost as soon as the talent and crew arrive on set by substantially speeding setting up/readying the next filming location and including pre-established workstations or positions such as for DIT, VTR, audio or sound recording and processing, and loading and copying of digital video cards/recordings, with an on-site power supply to increase the efficiency of the overall production.

In embodiments, the tow and/or transport vehicle(s) further can include a liftgate or integrated ramps to enable quick and easy loading and unloading of production equipment such as camera and audio equipment, color-correction, record and playback and audio recording equipment, etc., lighting, cabling, generators, etc., as well as a plurality of modular racks, shelves, hooks, or other storage features that can be removable or adjustable. For example, in embodiments, the cargo area could include foldable shelves and/or racks adapted to hold reels of cable (e.g., 50-100 ft. cables for connection power and/or data between the production equipment and various production stations of the mobile production command or control center), and in some embodiments, such racks could be connected to a to motor or other actuator o drive rotation of the cable reels to assist in winding or unwinding the cables carried thereby. In other optional embodiments, the cable reels themselves could include an integrated motor to assist in reeling and unreeling the cable (e.g., in some exemplary embodiments, over 1000 feet of data and/or power transmission cable).

In embodiments, the tow vehicle, and/or in some embodiments, a separate transport vehicle(s), also can transport a series of mobile production assemblies configured with components to support recording of video, sound, wireless transmission of data, playback of video, etc. on-set. In embodiments, such mobile production assemblies can be configured as carts. The carts further generally will be mobile, e.g., including wheels to enable the carts to be easily moved by a user. In some embodiments, the carts also can include a motor to assist in moving the carts, particularly over distances and/or over more uneven terrain. In embodiments, the carts can include compartments and/or racks in which a series of components such as video over fiber converters, Dante® audio converters, wireless audio receivers and antenna combiners, and various combinations thereof, can be received. In embodiments, the compartments or racks can include rack-rails, slides, drawers, or other supporting mechanisms that can be moveable into and out of the compartments to enable the quick change-out of components and for ease of connection thereof.

In some embodiments, the carts further can be configured to be modular, e.g., being expandable to enable additional components to be mounted therein and further can include power and/or data connections, wireless transmitters and on-board wireless modems, data line connections for transmission of audio, as well as video monitors, antennas and microphones other features. In addition, in embodiments, the carts can include an internal power supply, such as one or more batteries, and a power distribution component. In embodiments, the power distribution component can be configured to couple to an external power source and can have quick connect/disconnect connections to each of the components for distribution of power thereto.

In embodiments, multiple carts can be transported by the tow and/or transport vehicle(s) as part of the mobile entertainment production control system, including multiple carts configured to support video, and carts configured to support audio. For example, in embodiments, two or more video support carts and two or more audio support carts can be transported to each set location and can initially be connected in parallel and can operate as redundant systems.

In embodiments, once production has commenced, one set of carts can be disconnected and transported to a next location or area using the transport vehicle to enable the set-up and operation of production equipment (e.g., microphones, lighting, sound recording systems, color-correction, record and playback and audio recording equipment, mobile production assemblies, etc.) to be established and readied for a next shot or sequences of scenes such that once the filming crew, actors, etc. arrive, production (e.g., filming of the next scene(s)) can begin almost immediately.

In some embodiments, the carts can also include ports for chargers for recharging microphones and other wireless equipment, and wireless equipment and antennas for establishing wireless connections, e.g., such as for transmission of video to the mobile production command or control center and for video playback on monitors linked to the carts, and for intercom transmissions between crew members. In embodiments, each of the carts can be connected directly to the mobile production command or control center, including being connected by wireless and/or direct cable/data line (wired) connections. For example, in embodiments, the carts can communicate wirelessly with the mobile production command or control center, and further include wired connections to the mobile production command or control center (e.g., cables) to transmit video to the VTR production suite and audio/sound to the sound or audio processing suite.

In embodiments, the mobile production command or control center can include a trailer having a trailer body that can be designed in varying lengths and can have varying numbers, arrangements, and configurations of production suites. For example, in various embodiments, the trailer body can have a chassis or frame with an enclosure or housing mounted thereon, and which can have a selected length based on selected operations needed or desired to be performed as a filming location or site. For example, and without limitation, the trailer body could be constructed in different configurations and/or sizes (e.g., different lengths and/or different widths) to accommodate fewer or greater numbers of production suites and/or work stations.

In some embodiments, the trailer body can be configured as a modular system that can be expanded and/or reconfigured to enable additional production bays or suites to be added. In some further embodiments, the trailer could have a conventional expandable/collapsible configuration that can enable the production suites to be expanded during use on site, and thereafter reconfigured to more compact positions for transport.

By way of example only, without limitation, the production bays or suites of the mobile production center can include a series of positions and/or workstations; for example, a first position for the DIT technician and for color-correction, a second position for VTR and coloring of images from the recorded video footage, a third position that can be set-up as the audio or sound recording suite, and a fourth or “Loader” position for loading and copying footage from cards. Additional workstations or positions such as for an on-site engineer and other technicians can be established in one or more of the production bays or suites. The production bays or suites further can be isolated from one another, e.g., having doors therebetween, and each can include a separate access (e.g., doors and/or stairs).

In addition, in optional embodiments, a mobile control application for a mobile control device can be provided that is configured to enable communication with the production bays or production suites and control of production aspects associated with selected production suites of the mobile production control center. In embodiments, the mobile control application can be accessed from a mobile device such as an iPad, tablet, phone, or other device, and will be configured to help facilitate bi-directional communications between the trailer and the production equipment and carts to enable a user to change inputs and outputs (e.g., change camera views, request footage from a production suite such as the VTR suite, access other applications or systems for control of other aspects, such as isolating certain audio inputs on-set, etc.).

In some embodiments, the trailer body can also be configured with a fold-down doors (e.g., along a rear end or along a portion of one or more sides thereof) that can act as a ramp for loading and unloading equipment from the trailer body, such as for change-out of equipment in one or more of the suites. In still other embodiments, modular storage compartments can be provided within each production suite, e.g., folding racks, expandable bins, shelving, cabinets, etc., can be provided in each suite or bay. Each production bay or suite also can include sliding drawers or supports configured to enable VTR, DIT, and audio processing equipment to be removed and/or to be moved into and out of compartments, and to be pivoted or reoriented, to enable ease of access to the components as needed. In embodiments, the trailer body will also include air conditioning, heating units, and/or other environmental controls.

The mobile production command or control center/trailer further can include direct wired connections for transmission of data, including sound and video transmissions. For example, the trailer body can, in embodiments, include one or more data/power junctions (which can be part of or in addition to the power junction/connections between the tow vehicle and the trailer), adapted to connect to cables extending from a power source and from one or more data sources (e.g., from one or more carts). In embodiments, the cables can include conventional fiber optic cables (including 6-12 strands of fiber or more) stored on reels carried by the transport vehicle.

In addition, in some embodiments, the trailer body of the mobile production command or control center/trailer also could be fitted with cabinets along an exterior side of the body that can enable storage of components. For example, in an embodiment, lengths of cables to be stored on the trailer itself and which can be connected to the data/power junction of the trailer. In some instances, the mobile production command or control center/trailer could be installed at a filming location and connected directly to the carts that are prepositioned on site by onboard cables, without having to run and connect additional cabling, so as to enable faster set-up and take-down of a production site. This process can facilitate the “leapfrogging” of the production sequence whereby once an initial production location has been established, e.g., cameras, lighting, sound, etc. are set-up and at least one set of carts has been fully engaged and operating, the transport vehicle can be disconnected and used for the transport and set-up of production equipment, to include at least one other set of carts, at a next filming location so that when the mobile production command or control center/trailer is transported to the next location and data and wireless connections established, filming can start almost immediately thereafter.

In some optional embodiments, the trailer can be provided with solar panels and on-board power storage units or batteries that can be used to store and/or generate/supply power for operation of the suites. For example, in the event of an external power outage at a location and/or to help conserve the power supplied by the transport vehicle, the mobile production command or control center/trailer can be configured to supply at least a portion of the power needed to operate the production suites.

Accordingly, embodiments of systems and methods for the production of entertainment content, such as television programs, movies, news programs and other content or programing, including a mobile entertainment production control system configured which are directed to the above discussed and other needs, are disclosed. The foregoing and other advantages and aspects of the embodiments of the present disclosure will become apparent and more readily appreciated from the following detailed description, taken in conjunction with the accompanying drawings. Moreover, it is to be understood that both the foregoing summary of the disclosure and the following description are exemplary and intended to provide further explanation without limiting the scope of the present disclosure.

According to some aspects, a mobile entertainment production control system is provided and can comprise a mobile production command or control center; a tow vehicle; production equipment including video and audio recording equipment; and a series of mobile production assemblies; wherein the mobile production command or control center includes a plurality of stations or positions that can comprise a loading position, a video recording station, a digital imaging technician position, a sound recording position, or combinations thereof; and wherein the mobile production assemblies are configured to communicate video and audio data to one or more of the stations or positions of the mobile production command or control center.

In embodiments, the mobile production assemblies include at least two video production carts and at least two audio or sound carts.

In embodiments, the tow vehicle includes a power system configured to supply power for operation of the mobile production command or control center. In some embodiments, the power system will be configured to provide sufficient power for operation of the mobile production command or control center for at least twelve hours.

In further embodiments, the mobile entertainment production control system includes a mobile control application.

According to other aspects, an entertainment production control system, comprises a tow vehicle including a power supply assembly configured to be transported therewith; a mobile production control center comprising: a trailer configured to be operatively coupled to the tow vehicle for transport to a desired production set location, wherein the trailer has a trailer body defining a plurality of production suites that are configured for entertainment production operations to include filming and on-site copying, digital imaging, coloring, correction and processing of video and audio data, or combinations thereof, and wherein the plurality of production suites are electrically coupled to the power supply assembly of the tow vehicle to power operations thereof; a plurality of production equipment, wherein the plurality of production includes at least camera equipment; audio equipment, and lighting equipment; a plurality of mobile production assemblies configured to operatively couple the mobile production control center to a distributed set of the plurality of production equipment that are positioned about the desired production set location; wherein each mobile production assembly is configured as a cart, wherein the plurality of mobile production assemblies comprises a plurality of video support carts and a plurality of audio support carts; and wherein the plurality of mobile production assemblies includes a set of production carts comprising at least one video support cart and at least one audio support cart selected from the plurality of mobile production assemblies; at least one support vehicle, each support vehicle having a storage area configured to transport production equipment selected from the plurality of production equipment and/or the plurality of mobile production assemblies to a selected production set location; and wherein, while filming and on-site copying, digital imaging, coloring, correction and processing of video and audio data, or combinations thereof is on-going at a first geographic production set location, transporting the set of production carts via the at least one support vehicle to a second geographic production set location that is remote from the first geographic production set location.

In embodiments of the entertainment production control system, the set of production carts is configured to operatively couple the at least one video audio support cart and at least one video support cart to second distributed set of the plurality of production equipment that are positioned about the second geographic production set location.

In embodiments of the entertainment production control system, the set of production carts is configured to operatively couple the at least one video audio support cart and at least one video support cart to the mobile production control center upon arrival of the mobile production control center at the second geographic production set location.

In embodiments of the entertainment production control system, the plurality of production suites can comprises at least one least one loading position, at least one video recording station at least one digital imaging technician position, at least one sound recording position, or combinations thereof.

In embodiments, the plurality of production suites includes one or more digital recording monitoring and copying systems, audio recording and processing equipment, digital copying equipment, or combinations thereof.

In embodiments of the entertainment production control system, the power supply assembly includes a plurality of power storage unites positioned within a cargo area of the tow vehicle that are configured to enable selective transfer of electrical power from the plurality of power storage units to the plurality of suites and to the distributed set of the plurality of production equipment.

In embodiments of the entertainment production control system, the plurality of power storage units can provide electrical power for an extended duty period that is at least 48 hours.

In embodiments of the entertainment production control system, the plurality of power storage units comprises a plurality of batteries coupled to at least one invertor in a master/slave configuration.

In embodiments of the entertainment production control system, each inverter has a charge controller configured to monitor the charge of the operatively connected plurality of batteries.

In embodiments of the entertainment production control system, the tow vehicle includes at least one solar panel that is coupled to the at least one inverter and the plurality of batteries for supplying electrical power thereto.

In embodiments of the entertainment production control system, the tow vehicle is configured to accept external power to effect the desired charging of the plurality of batteries.

In embodiments of the entertainment production control system, each cart has a plurality of operation and production components positioned therein.

In embodiments of the entertainment production control system, each cart can have an internal power supply.

In embodiments of the entertainment production control system, each cart can be configured to connect to an external power source.

In embodiments of the entertainment production control system, selective operation and production components on the cart are configured to be selectively coupled to the plurality of production suites for operative data transfer therebetween.

According to other aspects, a method of producing movies and television programs comprises: delivering and setting up a plurality of production equipment to a first geographic production set location, wherein the plurality of production includes at least camera equipment; audio equipment, and lighting equipment; connecting the plurality of production equipment to a plurality of mobile production assemblies, wherein the plurality of mobile production assemblies comprises a plurality of video input/output assemblies and a plurality of sound input/output assemblies that are respectively configured to receive video and audio inputs from the production equipment; delivering a mobile production control center to the first geographic production set location via a tow vehicle including a power supply assembly configured to be transported therewith; enabling a power transfer between the power supply assembly and the mobile production control center; connecting the plurality of mobile production assemblies to the mobile production control center to enable transfer of video and audio data received by the mobile production assemblies from the production equipment to the mobile production control center once filming has commenced, selecting a set of mobile production assemblies from the plurality of mobile production assemblies, wherein the set of mobile production assemblies comprises at least one video/output assembly and at least one sound input/output; after filming has commenced at the first geographic production set location, moving the set of the mobile production assemblies to a second geographic production set location that is remote from the first geographic production set location via at least one support vehicle.

In embodiments, the method further comprises delivering and setting up a second plurality of production equipment to the second geographic production set location.

In embodiments, the method further comprises connecting the second plurality of production equipment the set of the mobile production assemblies.

In embodiments, the method further comprises connecting the set of the mobile production assemblies to the mobile production control center upon arrival of the mobile production control center at the second geographic production set location.

In embodiments of the method, each mobile production assembly can be configured as a cart.

Still other aspects, embodiments, and advantages of these exemplary aspects and embodiments, are discussed in detail below. Moreover, it is to be understood that both the foregoing information and the following detailed description are merely illustrative examples of various aspects and embodiments and are intended to provide an overview or framework for understanding the nature and character of the claimed aspects and embodiments. Accordingly, these and other objects, along with advantages and features of the present invention herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain the principles of the embodiments discussed herein. No attempt is made to show structural details of this disclosure in more detail than can be necessary for a fundamental understanding of the exemplary embodiments discussed herein and the various ways in which they can be practiced. According to common practice, the various features of the drawings discussed below are not necessarily drawn to scale. Dimensions of various features and elements in the drawings can be expanded or reduced to more clearly illustrate the embodiments of the disclosure.

FIG. 1A is a perspective view of an example embodiment of a tow vehicle for use with embodiments of a mobile production control center of a mobile entertainment production control system in accordance with the principles of the present disclosure.

FIG. 1B is a perspective view of an example embodiment of a mobile entertainment production control system in accordance with the principles of the present disclosure.

FIG. 1C is a perspective view of an example embodiment of a tow vehicle for use with embodiments of a mobile entertainment production control system in accordance with the principles of the present disclosure.

FIG. 2A is a top elevation view, with parts broken away, of an embodiment of a mobile entertainment production control system in accordance with the principles of the present disclosure.

FIGS. 2B and 2C are a side and a top elevational plan views of an embodiment of a tow vehicle for use with embodiments of a mobile production control center of a mobile entertainment production control system in accordance with the principles of the present disclosure.

FIG. 3A is an end view showing an example embodiment of a tow vehicle for use with a mobile production control center of a mobile entertainment production control system in accordance with the principles of the present disclosure.

FIG. 3B is a perspective view showing an example embodiment of a tow vehicle for use with a mobile production control center of a mobile entertainment production control system in accordance with the principles of the present disclosure and showing reels of fiber and a plurality of connected batteries.

FIGS. 4A-4D illustrate various embodiments of a mobile production control center in accordance with the principles of the present disclosure.

FIGS. 5A-5B are perspective views illustrating example embodiments of mobile production assemblies of a mobile entertainment production control system in accordance with the principles of the present disclosure.

FIG. 6 is a flow diagram illustrating and embodiment of connectivity and signal flow between the mobile production control center and on-set mobile production assemblies in accordance with the principles of the present disclosure; showing exemplary embodiments of workstations associated with a plurality of production suites of the mobile production control center, which can include, in non-limiting embodiments, a Loader suite or position, at least one DIT suite or position, at least one VTR suite or position, at least one audio or sound recording and processing suite or position, an Engineering suite or position, or combinations thereof, and which are in communication with a mobile Sound input/output cart and a mobile Video input/output cart of the mobile production control system in accordance with the principles of the present disclosure.

FIGS. 7A-7J illustrate example embodiments of a mobile control application for a mobile control device that can be configured to enable communication with the production bays or production suites and communication and control of production aspects in operation of the mobile production control system according to the principles of the present disclosure.

### DETAILED DESCRIPTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a cart” can include two or more such carts unless the context indicates otherwise. The terms “or” and “and/or” as used herein are to be interpreted as inclusive or meaning any one or any combination.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Spatially relative terms, such as “beneath,” “below,” “lower,” “above,” “upper,” and the like may be used herein for ease of description to describe one element's or feature's relationship to other element(s) or feature(s) as illustrated in the figures. It will be understood that spatially relative terms are intended to encompass different orientations of a device, system, or component in use or operation in addition to the orientation depicted in the figures.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “can,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular embodiment.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed but are used merely as labels to distinguish one claim element having a certain name from another element having a same name (but for use of the ordinal term) to distinguish claim elements.

Disclosed are components that can be used to perform the disclosed methods and systems. These and other components are disclosed herein, and it is understood that when combinations, subsets, interactions, groups, etc. of these components are disclosed that while specific reference to each various individual and collective combinations and permutation of these cannot be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems can be understood more readily by reference to the following detailed description of preferred embodiments and the examples included therein and to the Figures and their previous and following description.

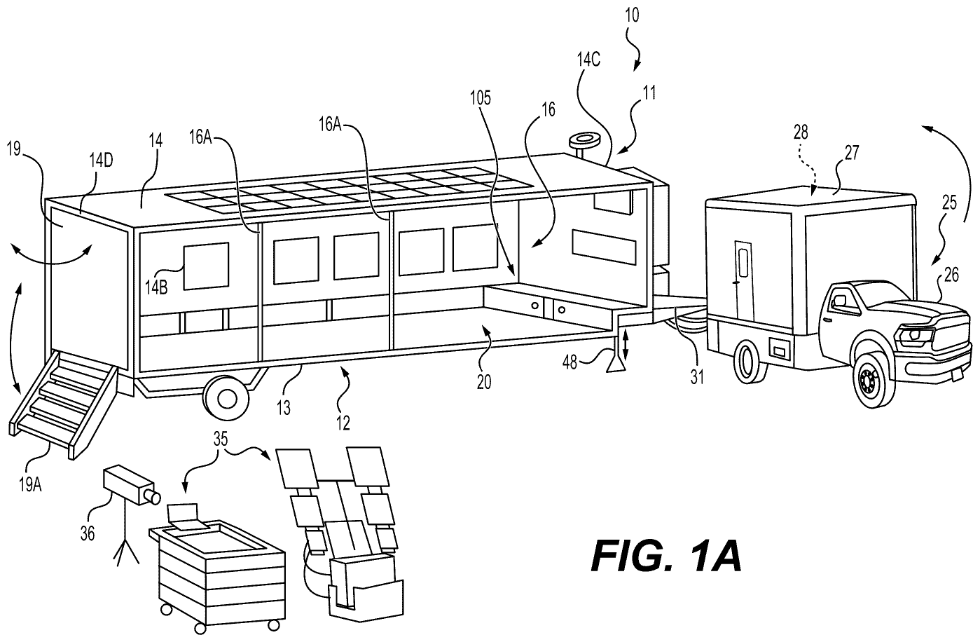

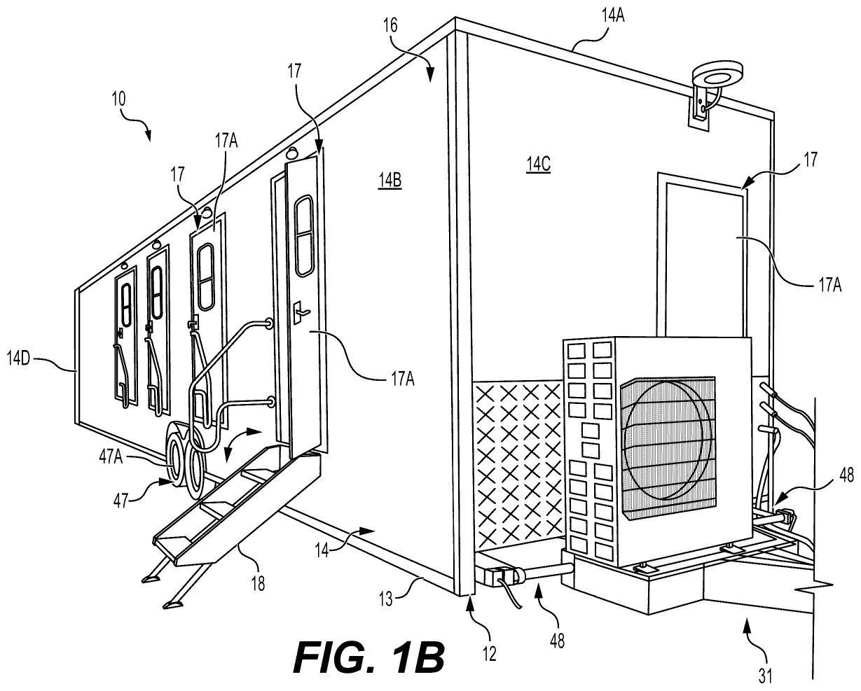

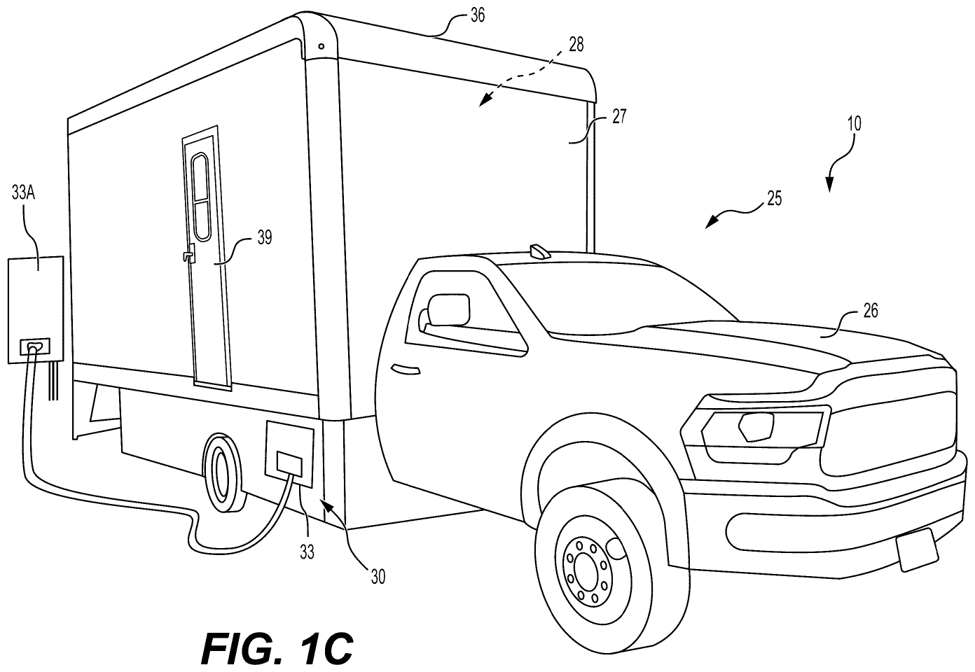

Referring now to the drawings, FIGS. 1A-4D illustrate various embodiments of a mobile entertainment production control system 10 according to the principles in the present disclosure. As shown in FIG. 1, in embodiments, the mobile entertainment production control system 10 can comprise a mobile production command or control center 11 that can comprise a trailer 12 having a frame or chassis 13 and a trailer body 14 that can be constructed or configured with a series of performance bays or suites 20 designed for various production operations at a filming location for production of entertainment content such as movies, telephone shows, remote and/or live reporting, etc. In addition, the mobile entertainment production control system further will include a tow vehicle 25 and, in some embodiments, one or more transport or supply vehicles.

It will be understood that the mobile production command or control center, in embodiments such as illustrated and discussed herein, generally can comprise, for example, a trailer configured with production control features and systems, and may be referred to hereafter as the “trailer,” without necessarily limiting such a mobile production command or control system to a trailer of a particular configuration or having a particular arrangement of production suites, positions or workstations, or production systems/equipment.

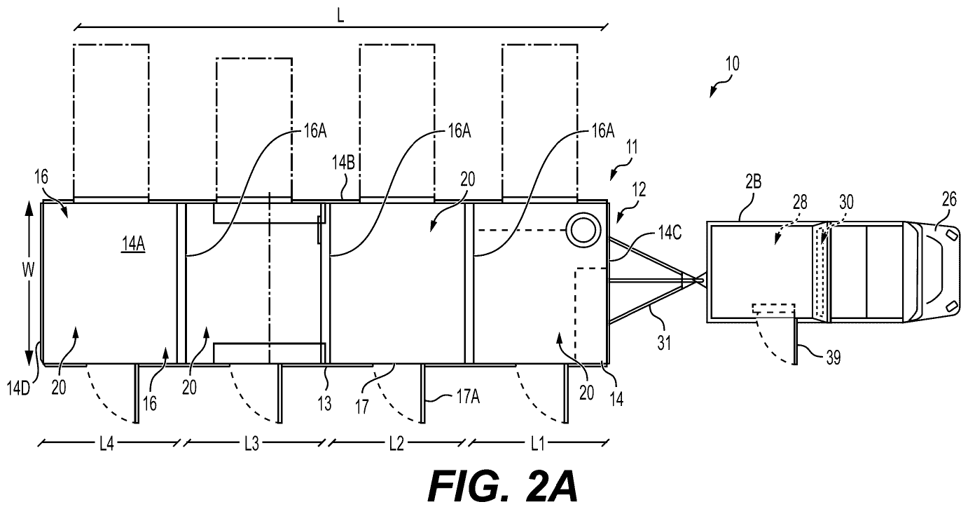

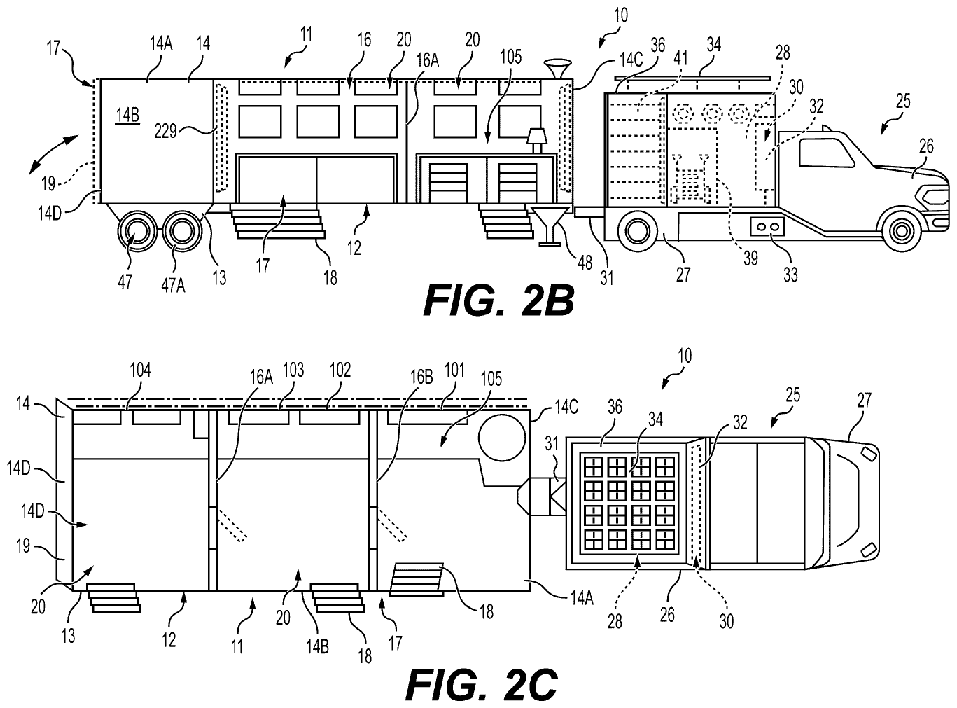

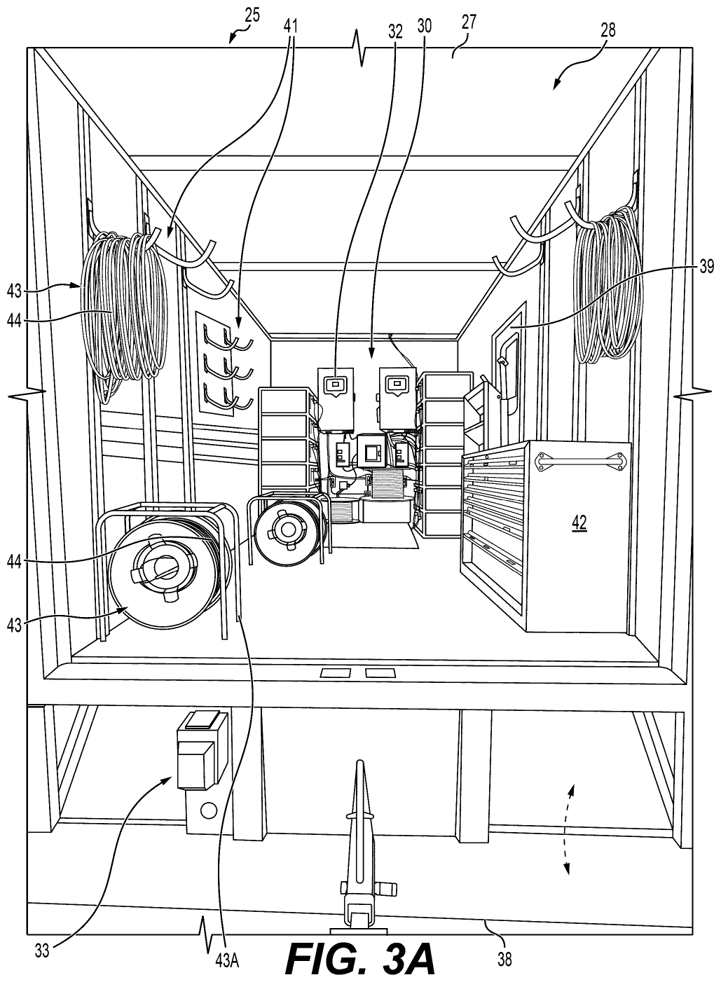

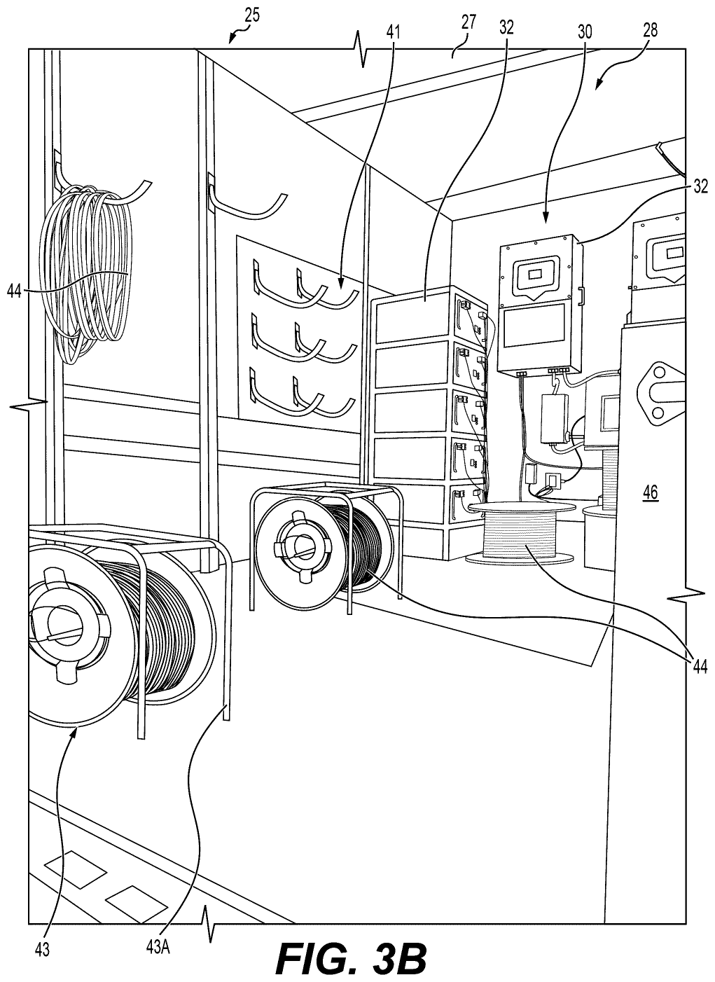

In embodiments, such as shown in FIGS. 1A, 1C and 2C, the tow vehicle 25 can comprise a truck or other vehicle having a sufficient towing capacity for towing the mobile production center 20 (e.g., a trailer including production control features and systems) to a variety of locations, including remote locations with uneven terrain and/or limited access. For example, in embodiments, the tow vehicle 25 can comprise a box truck or similar vehicle having a drive section 26 and a storage section 27 configured with a selected cargo capacity; for example, in embodiments, having an enclosed cargo area 28 (FIGS. 2A-3B) configured to store and enable access and quick loading and off-loading of various production equipment or components, such as, for example and not meant to be limiting, reels of fiber 29 used for operative connection of various production equipment or components.

In embodiments, the mobile command or control production system 10 can include at least one transport vehicle that can be used to move selected production equipment 35 (FIG. 1A). In embodiments, the at least one transport vehicle, such as a box truck or similar vehicle, can be provided for transport of desired production equipment. In embodiments, the transport vehicle also can include a lift gate, ramps, fold out doors or other features to enable easy loading and unloading. In some embodiments, the transport vehicle also could be used as an additional power source for the mobile production command or control center, various production systems and/or equipment, or combinations thereof.

Still further, in optional embodiments, a transport vehicle can be used to transport the mobile production command or control center 11 to a site and can include at least a portion of the functionality of the tow vehicle. For example, in some embodiments, the tow vehicle 25 could (once filming at the location or site has wrapped) be used to transport the carts to a next site while the mobile production command or control center completes various production operations and readies for transport. Then, once it arrives at the new site, it may be just a matter of connecting it to the tow vehicle for power to the mobile production assemblies 50 already on-site to start production. Alternatively, a transport vehicle can be used to transport the carts while the tow vehicle stays with the trailer.

In embodiments, each transport vehicle has a storage area configured for transportation of select video/sound production equipment 35. In one optional example, it is contemplated that respective transport vehicles can be dedicated to respective production departments such that the camera department can have a dedicated camera transport truck for transport of cameras 36; the grip and/or sound departments also each can have a dedicated transport truck; the electrical department can have a dedicated electric transport truck; the video and/or audio cart department can have a dedicated video and/or audio equipment transport truck, etc.

In embodiments, the tow vehicle, and/or a dedicated video and/or audio cart transport truck can be used to transport a plurality of mobile production assemblies 40 (FIGS. 1A and 5A-6) that are needed to connect the mobile command or control production center 11 (FIG. 1A) to a distributed set of set of cameras 35 and sound devices, such as microphones, etc. for initial processing and transfer of recorded data to the production suites 20.

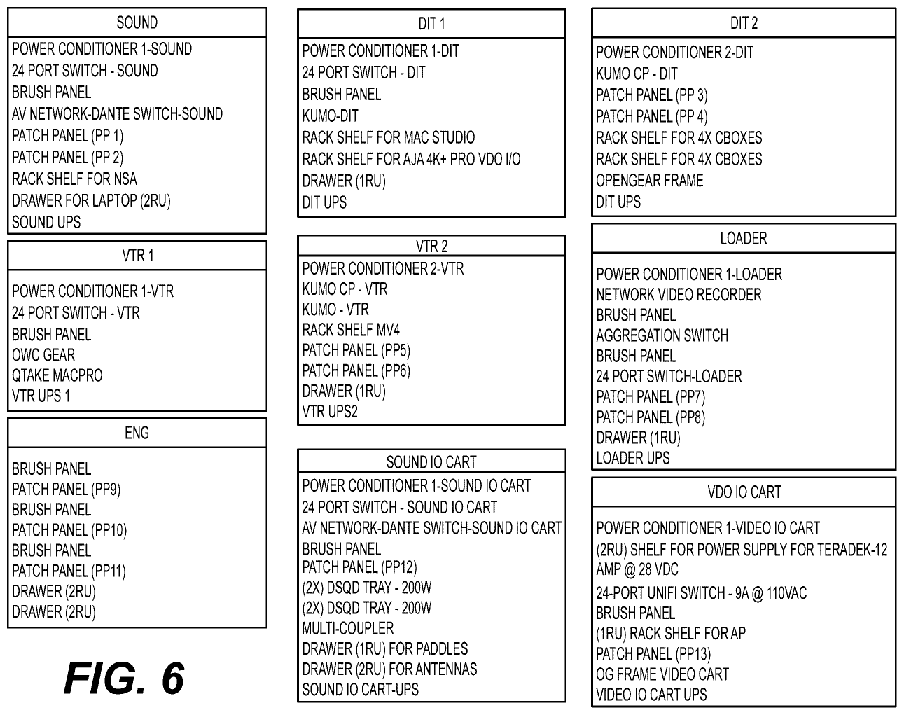

In embodiments, and as described herein, each plurality of mobile production assemblies 50 can include at least one video cart 51 (FIG. 6) and at least one sound cart 52. In embodiments, it is contemplated that the video and/or sound cart transport and/or the tow vehicle can transport a respective mobile production assembly 50 to a next desired geographically distant set location to be coupled to cameras, microphones, grips, and other audio/video production equipment that are also positioned as desired at the geographically distant set location (e.g., according to a location plan or site coordinator's direction).

As contemplated, and as described in more detail below, the mobile production control system 10, and the components thereof allows for the on-site processing and the set-up of production equipment or components for filming at geographically spaced production sites and allows for the execution of a leapfrog operation in entertainment production operations to increase efficiency and productivity in the set-up, filming and production of scenes.

As shown in FIGS. 1B and 2A-2C, the tow vehicle 25 can couple to the mobile production command or control system 11, also referred to hereafter as the trailer 12 by a tow hitch 31, or similar coupling. In embodiments, the tow vehicle also could be configured to supply power and/or provide further data connectivity, in addition to transport thereof. For example, in embodiments, the tow vehicle can have power and data line connections that can be incorporated in/located along the tow hitch 31 for transfer of power from the tow vehicle to the trailer to power the operations thereof.

In some embodiments, the cargo area of the tow vehicle can be configured with power system 30 that, in embodiments, can include a series of batteries 32 or other power storage units 28 (FIGS. 3A-3B), and can have an integrated power connection or junction 33 (FIG. 1C) linked to the batteries and which can be accessible from outside the cargo area of the tow vehicle 25 to couple to an external power source as needed. In embodiments, a plurality of batteries can be mounted within the cargo area of the tow vehicle. The plurality of batteries can have varying selected capacities and can be replaceable. It is contemplated that other conventional components such as, for example, inverters, charge controllers, and power collection nodes can be connected to the batteries and to the power connection or junction of the tow vehicle to enable transfer of power from the batteries to the trailer and to externally located production equipment.

By way of example, in one exemplary embodiment, the power system 30 can include a plurality of lithium phosphate batteries coupled to at least one inverter in a master/slave configuration. For example, and without limitation, the plurality of lithium phosphate batteries can include 12 lithium phosphate batteries that are operatively coupled to a pair of inverters in a master/slave configuration. In embodiments, each inverter can include a charge controller that is configured to monitor the charge of the operatively coupled batteries and allow electricity to pass through for charging purposes. As one will appreciate the charge controller is configured to sense the charge increase in the coupled batteries and as the capacity of the coupled batteries nears a percentage of full charge, charging capacity is reduced to protect the coupled batteries.

In some embodiments, the tow vehicle 25 also can include solar panels 34 that can be positioned along the roof 36 thereof, and which can be connected to the at least one inverter and the on-board plurality of batteries for supplying power thereto. Optionally, the tow vehicle 25 can be configured to accept shore power to effect the desired charging of the plurality of batteries, such as shown in FIG. 1B. Still further, in some embodiments, an additional back-up generator can be connected to the plurality of batteries or can be used to power the production systems and equipment as the batteries become depleted.

In embodiments, the power connection or junction of the tow vehicle 25 also can include a series of power and data input connections and output connections 33 (FIG. 3A) to enable the tow vehicle to act as an on-site power source for the production equipment and the trailer 11 systems during filming and for collection and transmission of data as needed, as well as for connection of the batteries 32 to an external power source as needed for charging the batteries 32. Optionally, the power connection or junction 33 of the tow vehicle also can include a switching system that can be configured to change between external power 33A (FIG. 1C) and the on-board power system.

In some embodiments, the tow vehicle can also include wireless connectivity, such as a wireless modem, and in some embodiments can function as a wireless hotspot for receipt and retransmission of data as required.

The tow vehicle 25 will provide power to the trailer, and, in embodiments, can be adapted to also provide power for equipment such as lighting, cameras, etc. for an extended period of time and can be disconnected from such components as desired when external power source/connections have been established. For example, in embodiments, the tow vehicle can have sufficient batteries/power storage capacities to supply sufficient power to operate the production systems of the trailer and other production equipment for an extended operations/filming period. In embodiments, the operations/filming period preferably can be at least 12 hours, at least 24 hours, at least 36 hours, and, most preferred, at least 48 hours. It is contemplated that the tow vehicle thus can, in embodiments, be used as a primary power source for the production systems of the trailer, as well as for on-site production equipment such as cameras, sound recording systems, lighting, etc., during production/filming at locations outside a soundstage and/or studio. This capability enables the production and processing of entertainment content by the trailer to be substantially self-sufficient, e.g., filming, digital copying and processing, sound review, video routing and review, etc., even at remote locations. Optionally, it is contemplated that portable power stations can be provided that have battery capacities for upwards of 8 hours of power to run cameras, carts, etc.

In embodiments, the tow vehicle 25 (and the transport vehicles) further can include a liftgate 38 (FIG. 3A) or integrated ramps, to enable quick and easy loading and unloading of components such as camera and audio equipment, lighting, cabling, additional power generators, etc. In addition, in embodiments, the tow vehicle can have at least one other access point (e.g., through a door 39), and the cargo area 28 the tow vehicle 25 can be provided with a plurality of modular racks 41 and other storage devices or compartments, such as a storage box or chest 42, which can include drawers, door, etc. to access a space therein. In embodiments, the racks can include hooks, etc. that can be configured to lock into place and can be removable or adjustable as needed to accommodate storage of different production components or equipment.

In embodiments, the cargo area 38 of the tow vehicle 25 and the transport vehicle(s) also could include a series of mounting brackets to be configured to enable shelving, racks, hooks or other storage devices, to be quickly and easily mounted your removed area types of production equipment configurations /d/ sizes thereof being transported. For example, in embodiments, the cargo area 28 could include foldable shelves or racks 41 adapted to hold reels 43 of cable 44 (e.g., cables for connection power data between the production equipment and various production stations of the trailer), and in some embodiments, such racks could include connections to motors or other actuators that can drive rotation of the reels to assist in winding or unwinding the cables supported or carried thereby.

In other embodiments, as shown in FIGS. 3A-3B, the cable reels 43 themselves can be mounted on portable stands or frames 43A, and could include an integrated motor or other actuator to assist in reeling and unreeling the cable (e.g., in embodiments, each reel could carry over a desired length of data and/or power transmission cable and could include a motor, such as a servo motor (e.g. a pancake motor) and power supply). In operation, it is contemplated that the desired length of data and/or power transmission cable 44 can be at least 50 feet, preferably at least 100 feet, and, in embodiments, at least 500 feet, or at least 1000 feet.

In addition, in embodiments, the tow vehicle 25 and one or more transport vehicles can each be used to store and transport a portion of the cable reels 43 (e.g., a desired number of the cable reels can be transported by the transport vehicle to provide a ready supply of such cables for transport to the next geographically spaced production site as part of a leapfrog production operation.

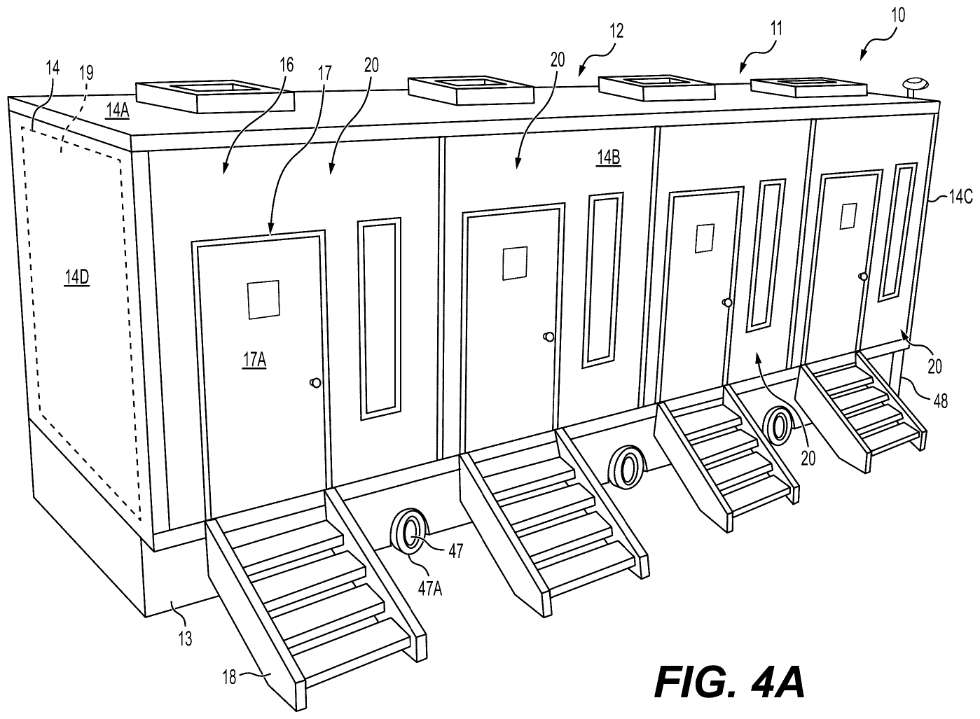

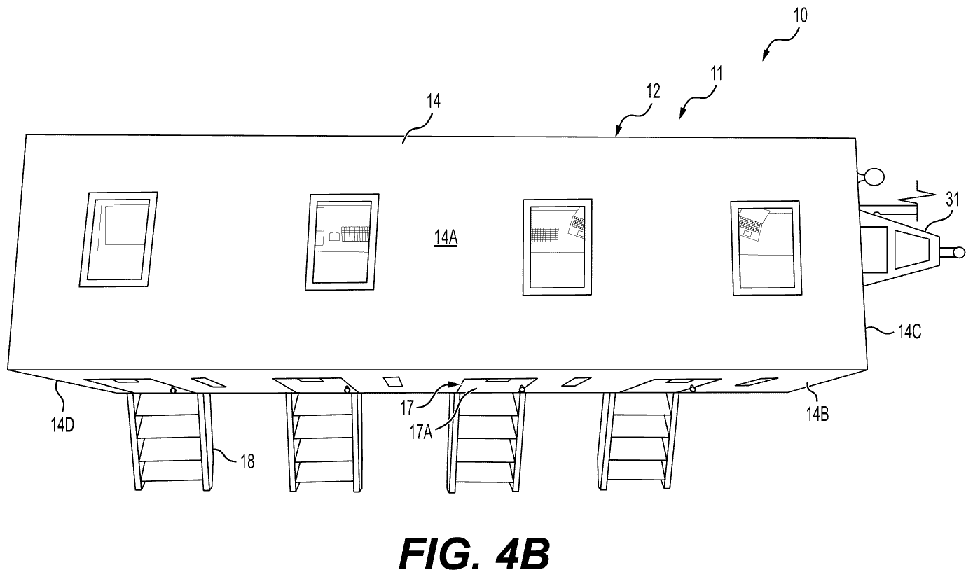

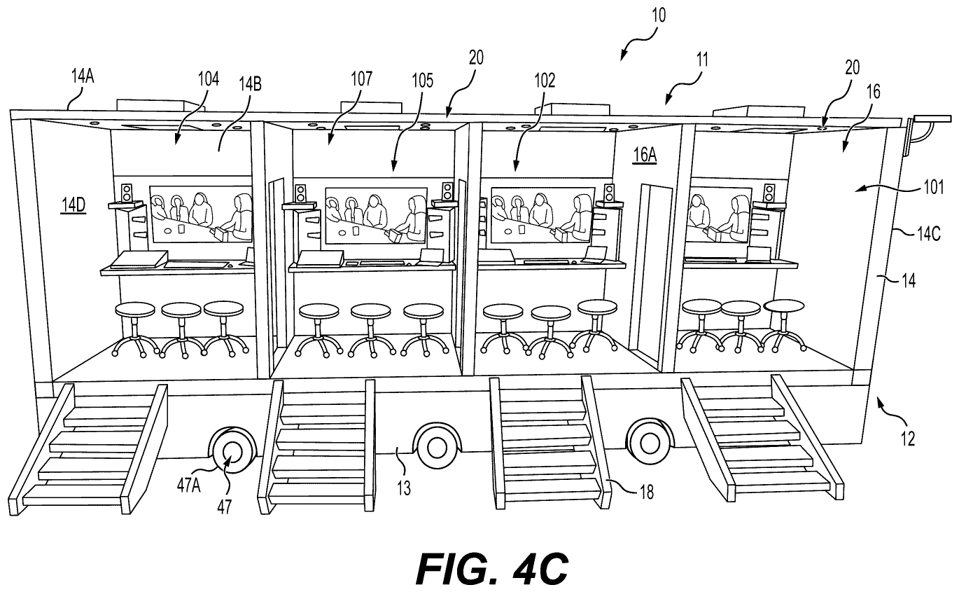

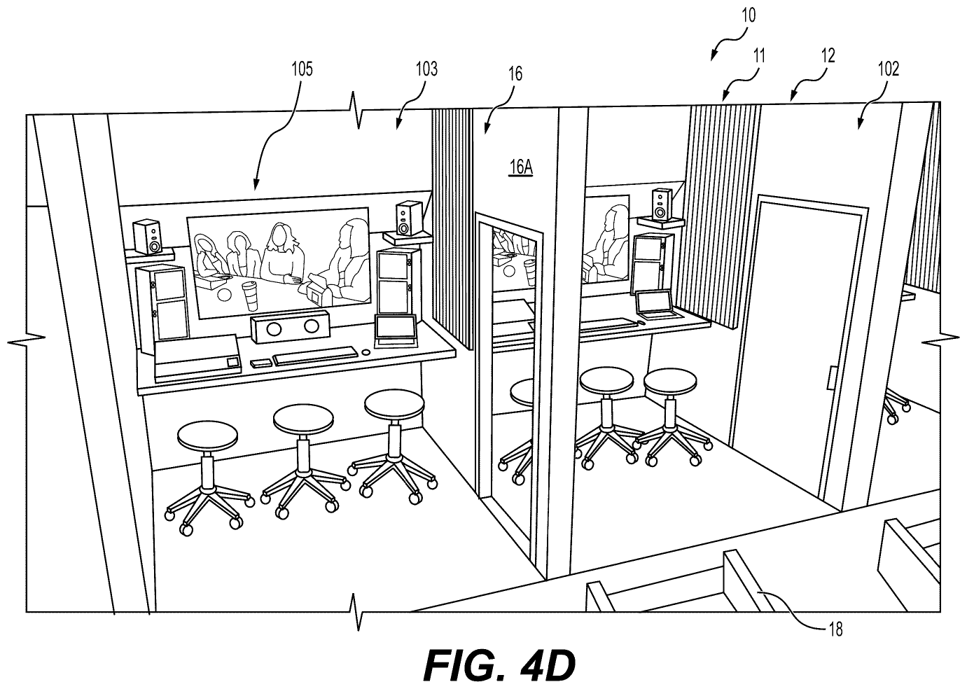

In embodiments, such as shown in FIGS. 1A and 4A-4D, the trailer 12 can be configured with any number of production bays or suites 20, with the FIGS. 4A-4D illustrating the use of four production suites as simply an exemplary embodiment for purposes of illustration and are not intended to be limiting. It furthermore will be understood that it is contemplated that a greater or lesser number of production suites also can be used. In one aspect, the production suites can comprise a plurality of production suites. For example, FIGS. 1A and 2A illustrate three production suites 20.

As shown in FIG. 2A, the trailer 12 will include a body 13 having a Length L and a Width W. The Length L of the trailer body 14 can, in embodiments and without limitation, range from approximately 20 feet in length to approximately 40 feet in length, and in some embodiments, a length of approximately 25 to 35 feet in length, and in still other embodiments, a length of approximately 30 feet. In some embodiments and without limitation, the width W of the trailer body 14 can range from approximately 8 to 15 feet, and in some embodiments, approximately 8-12 feet, and in other optional embodiments, a width of approximately 8-10 feet. It is contemplated that other trailer lengths and widths can be used. Each of the production suites 20 further can be configured with varying lengths depending on the production operations being conducted therein and/or the available space. For example, in the non-limiting embodiment shown in FIG. 2A, each of the four production suites 20 can have a length L1-L4. It is further contemplated that the lengths also can be varied based on the number of production suites and the configurations thereof.

In embodiments, the trailer chassis 13 can be configured with one or multiple axels 47 supporting one or more pairs of wheels 47A, the number of which can be dependent on length and capacity of the trailer. In addition, in some embodiments, the trailer 12 also can include extensible supports or jacks 48 located at one or more corner of the trailer body 14 and/or at other locations, and which can be extended into engagement with the ground to provide support and stability to the trailer once in place. The extensible supports could include hydraulic or pneumatic jacks, motor actuated supports, or other types of supports, and can be selectively actuated to help stabilize the trailer when positioned along sloped and/or uneven terrain. In addition, in embodiments, the extensible supports could be used enable the trailer to act as a substantially free-standing production control center or structure.

Exemplarily, in some embodiments, such as indicated in FIGS. 4A-4D and 6, the plurality of production suites 20 of the trailer 12 can include a Loader suite or position 100, a DIT suite or position 101, a VTR suite or position 102, and an audio or sound recording and processing suite or position 103. It is further contemplated that the plurality of production suites can include additional production suites can be provided such as for engineering or other operations. Still further, in embodiments, each production suites can be provided with one or more workstations 105, such as illustrated in FIGS. 1A, 2A, 3A-3C, 4A-4D and 6. In addition, in embodiments, the trailer can be reconfigurable to provide for more or fewer production suites, and in some embodiments, can be configured to be linked with other trailers to provide additional production suites and/or processing capabilities (e.g., a trailer with 2-3 production suites, such as the loading and DIT positions can be provided and another trailer with the VTR and sound/audio production suites for video and sound/audio processing, or other operations, can be linked therewith), and to further facilitate the leapfrog production operation by enabling some production systems, such as loading and DIT to be transferred to a new site while the VTR and sound/audio suites can remain at the first site to complete processing of the recorded video and audio/sound data.

As exemplarily shown in FIG. 6 and without limitation, it is contemplated that the mobile production control center and on-set mobile production assemblies (such as the illustrated mobile Sound input/output cart and a mobile Video input/output cart) can be operatively coupled to the mobile production control center to allow for operatively data and or power communication therebetween. For example, in embodiments such as illustrated in FIG. 6, exemplary embodiments of workstations that are associated with a plurality of production suites of the mobile production control center include a Loader suite or position (LOADER), at least one DIT suite or position (DIT 1 and DIT 2), at least one VTR suite or position (VTR 1 and VTR 2), an audio or sound recording and processing suite or position (SOUND), and an Engineering suite or position (ENG). As described herein, it is contemplated that data communication between the plurality of production suites and between the production equipment and the mobile production control center can be conducted using wired communication connection protocols, wireless communication connection protocols, and/or a combination of wired and wireless communication connection protocols.

In embodiments, the trailer body 14, a roof 14A, side walk 14B, a front wall 14C and a rear wall 14D, defining an enclosure 16, in embodiments, can include interior walls 16A separating each of the production suites 20. In embodiments, each production suite can include a door or partition 16B to control access and/or movement between the respective production suites. In addition, the interior walls of the trailer can be provided with sound proofing and insulation.

As further illustrated in FIG. 1A, in embodiments, a plurality of access points 17A can be provided along one or both sides of the trailer body. For example, each of the production suites can have its own door 17A along a side 14A of the trailer body and additional access points with doors or panels 17B can be provided along the front and rear sides of the trailer body for access from the outside thereto. In embodiments, the access points can include a door or a ramp, e.g., as indicated in FIG. 1A. In other embodiments, the access points can be configured without a ramp, and with each production suite including its own exterior opening door 17A, while in further embodiments, not all of the production suites may have a door 17A. In embodiments and as shown in FIGS. 4A and 4C-4D, each production suite 20 further can include a series of extendable stairs 18 positioned adjacent an access point. In embodiments, the stairs can be extended for access to a production suite and can be collapsible or can be slid into the suite or up under the body of the trailer storage during transport of the trailer.

Still further, in some embodiments, the rear wall 14D of the trailer 12 can be configured with a door 19 that can be opened for wider access to the interior enclosure 16 of the trailer. In operational embodiments, the door 19 of the rear wall of the trailer can be a fold down door or ramp, which can swing on hinges. Optionally, the rear wall of the trailer can include as a roll-up type door to enable later access to the interior of the trailer body, such as for removal of components of the workstations or other items that may be stored within the trailer during transit. In addition, in still other embodiments, one or more access panels 17B can be provided along the opposite side of the trailer body from the doors can be associated with one or more of the production suites 20 or the workstations 105 to therein enable access to workstation components for repair or changeout thereof.

As further illustrated in FIGS. 4C-4D, a workstation 105 for each production suite 20 can be provided with monitors, computers, video monitoring, copying and editing, including equipment for loading and copying of digital cards, color-correction, audio mixing and recording, copying and editing equipment, video recording and playback equipment, and/or other components. In embodiments, the production suites also can include a work space with a desk or table and seating. In embodiments, such a desk can comprise a modular and/or reconfigurable desk, such that each workstation can be reconfigured as needed to rearrange components, to add extra working positions, to add or remove seating for a technician or engineer, for ease of disassembly or combinations thereof.

In addition, in some embodiments, the components such as computers, video monitors, recording components and the like can be mounted on sliding and/or pivoting support frames to enable such components to be moved or repositioned as needed (e.g., such as, when they bays are being reconfigured for other production operations), and/or for easy access thereto for repair and changeout of such production components. It further will be understood that while FIGS. 1A and 4B-4D illustrate example various configurations or layouts of production suites, and positions and/or workstations within each production suite, as well as examples of and components such as video monitors and computers, other, varying configurations the production suites, positions, workstations, and/or components can be used.

In embodiments, the interior enclosure 16 of the trailer body can be provided with cabinets, shelving, racks, bins, etc., at least some of which can be configured to be easily reconfigured, replaced, removed, or collapsed when not in use. In addition, in some embodiments, the trailer body could be fitted with cabinets along an exterior side of the body that can enable storage of components. For example, in an embodiment, lengths of cables could be stored on the trailer itself and which can be connected to the data/power junction of the trailer. In some instances, the trailer can be installed at a filming location and connected directly to the carts and other production equipment by the onboard cables, without having to separately run cables from stand-alone cable reels to the trailer so as to enable faster set-up and take-down of a production.

In embodiments, each of the production bays or suites 20 of the trailer 12 can include their own lighting and environmental controls. For example, an air conditioning unit 90 (FIG. 1B) and/or heating unit(s) can be mounted along a front end or along the top of the trailer and venting can be provided along the trailer body to enable cooled air and/or heat to be supplied to each production bay or suite. In some embodiments, each production bay or suite can have its own A/C and/or heating units.

In some further embodiments, skylights and windows can also be provided along the trailer body, e.g., along at least one side wall thereof and/or along the roof (FIGS. 4A-4B) of the trailer body, to enable ambient light into the production suites. In addition, one or more wireless antennas also can be positioned along the trailer, and in some further embodiments, LED screens or monitors can be located along one or more side panels of the trailer.

In embodiments, in addition to color-correction, record and playback, audio recording equipment, etc., the production equipment carried by the tow and/or transport vehicles can include a plurality of mobile production assemblies 50 (FIG. 1A). In one embodiment, the plurality of mobile production assemblies will include at least one video input/output (I/O) mobile production assembly 50, configured to communication with the trailer for transfer of video data between the cart and the DIT suite of the trailer (e.g., over a fiber cable, or, in embodiments, wirelessly) and at least one sound mobile I/O production assembly 50 in communication with the trailer for transfer of audio data between the cart and the sound/audio suite.

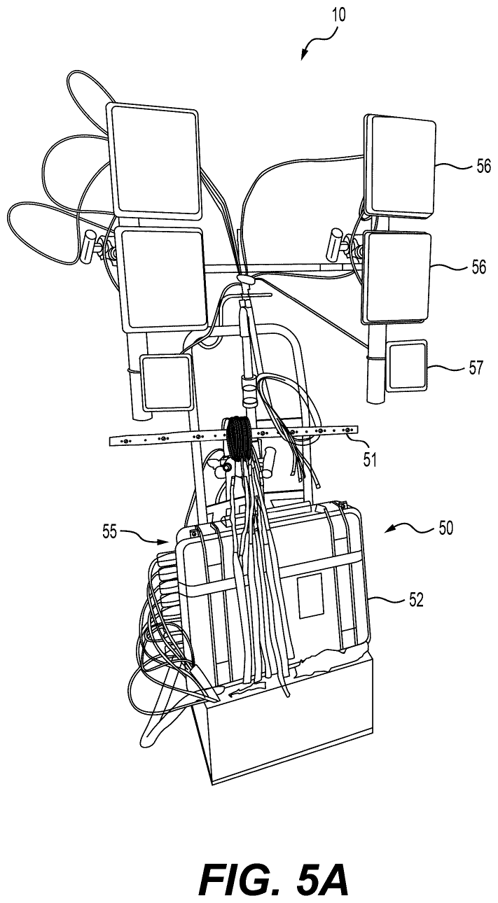

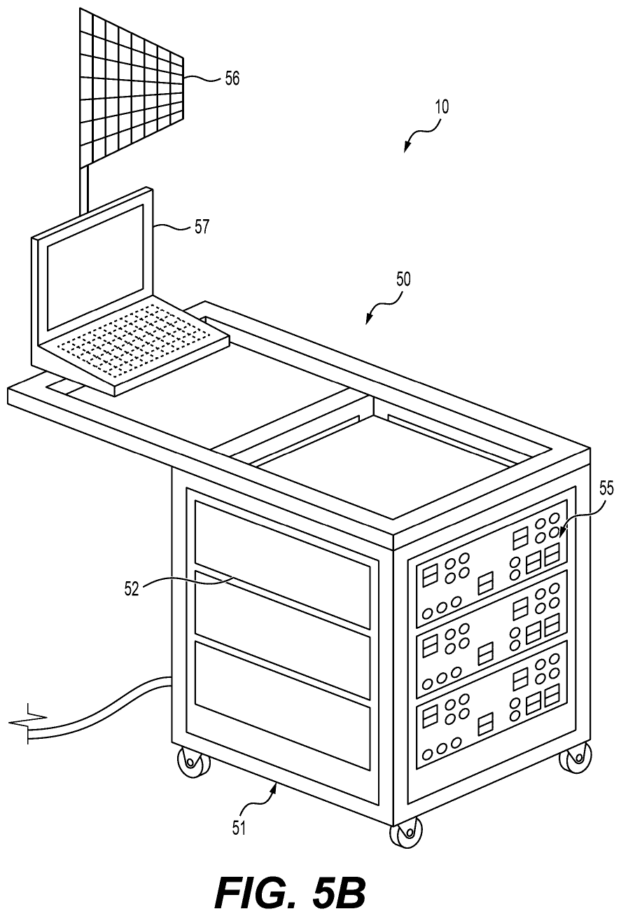

As exemplarily shown in FIGS. 5A-5B, in embodiments, each mobile production assembly 50 can be configured as a cart and may be referred to herein as a cart. In exemplified embodiments, each cart 50 can include a frame 51, which can include or comprise a rack, in which a series of operational components 55 such as, for example and without limitation, video over fiber converters, Dante® audio converters, wireless audio receivers and antenna combiners, or various combinations thereof, can be received. It is also contemplated in further embodiments that each cart can include wireless transmitters, wireless intercom connections, and on-board wireless modems, as well as video monitors, antennas and microphones and/or other features. In addition, in some embodiments, such as indicated in FIG. 5A, the carts can include antennas or transmitters/receivers (in some embodiments, including secondary receivers) mounted on masts and configured to communicate wirelessly with corresponding transmitters/receivers linked to, for example, cameras at a filming location. Such masts can be used to adjust a position of the antennas as needed to help provide a more direct line of sight between the antennas or transmitters/receivers mounted thereto and the transmitters/receivers linked to the cameras.

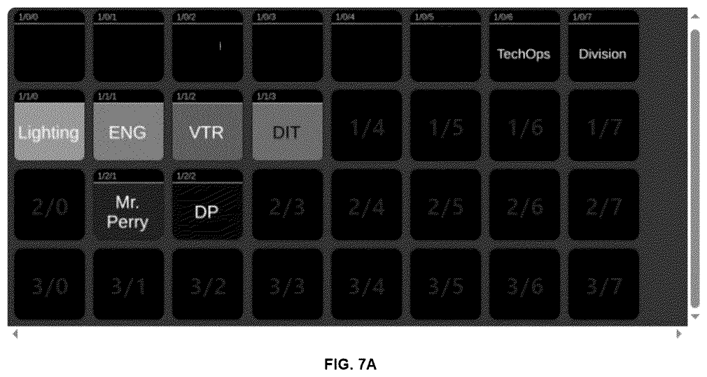

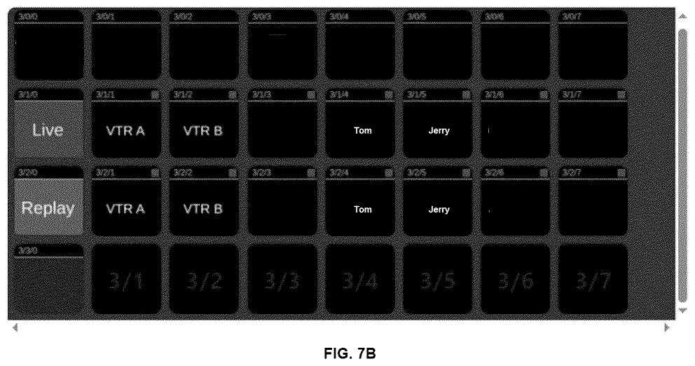

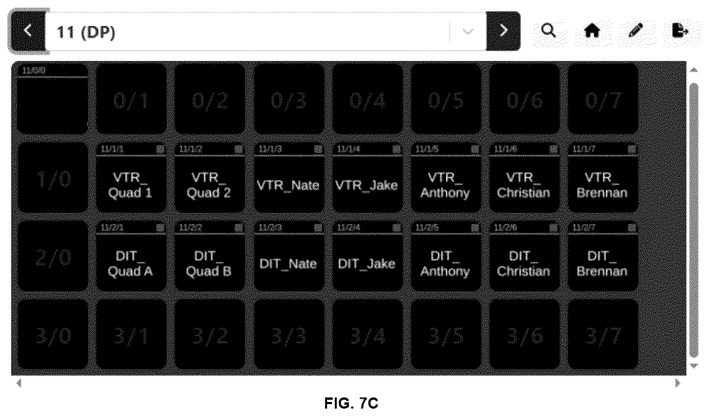

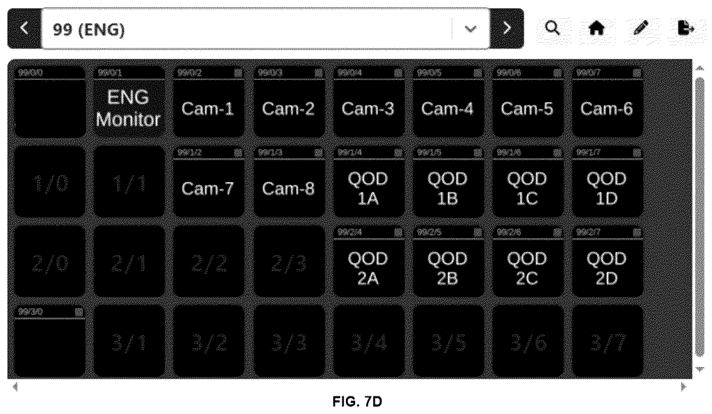

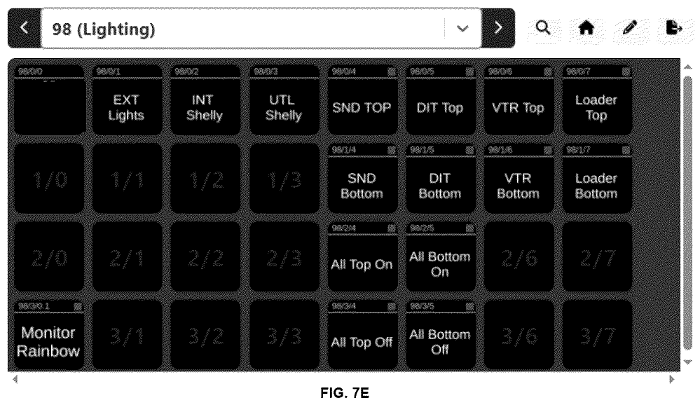

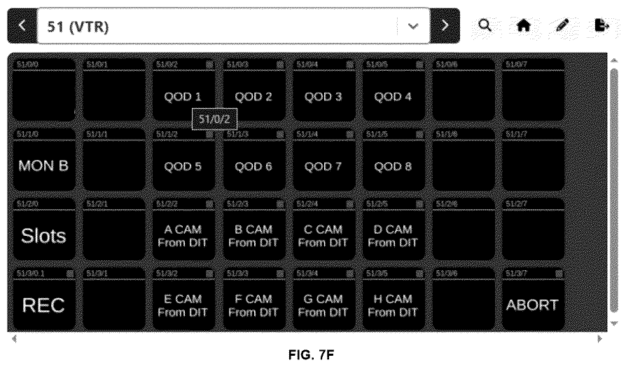

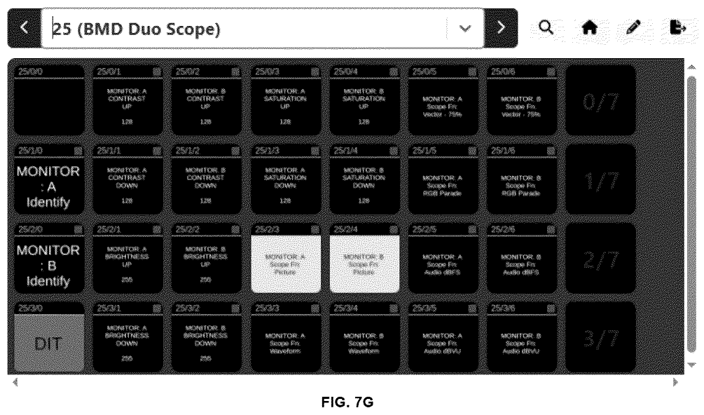

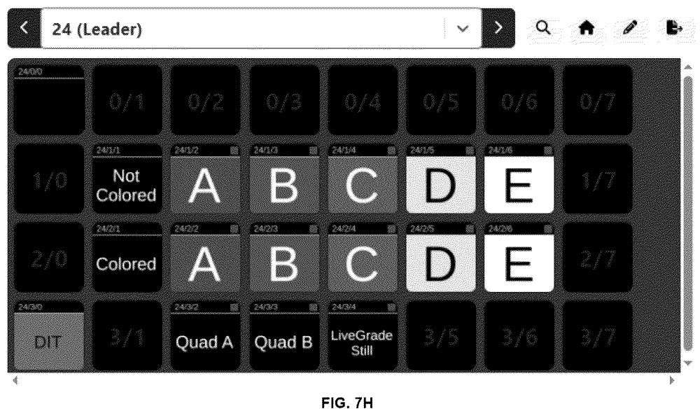

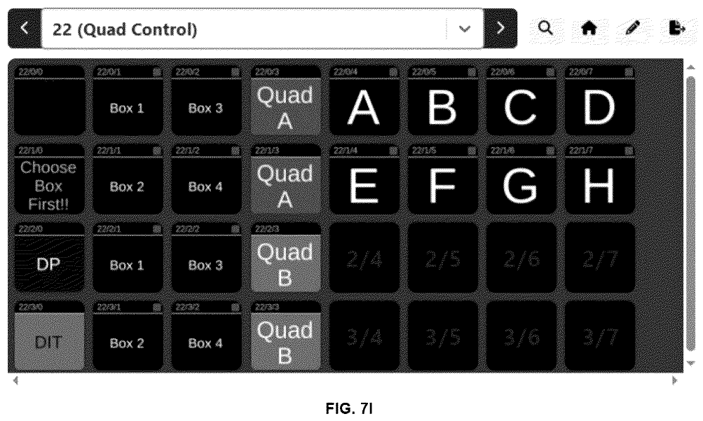

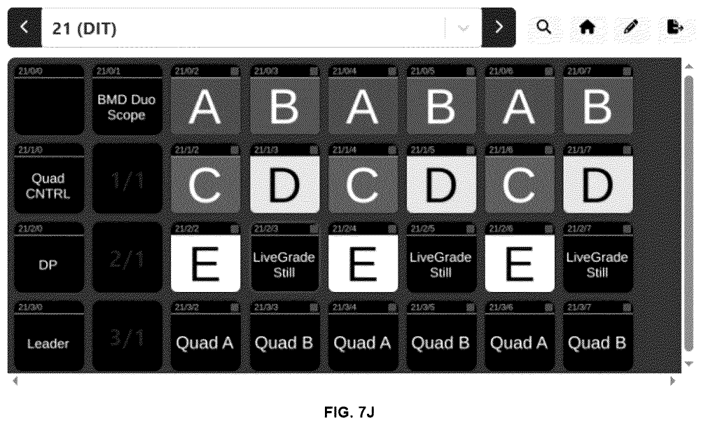

Still further, in some embodiments, the carts can be configured with networking systems/connectivity equipment, such as network switches, to enable a local area network (LAN) to be established at a filming location or site, for example to help facilitate wireless communications between crew members, and to provide increased security for wireless transmission of data between the carts and the production suites of the trailer, and with production equipment such as the cameras and audio recording and mixing equipment. For example, as discussed below with respect to FIGS. 7A-7J, the mobile entertainment production control system can include a mobile control application that can be provided on a handheld device and can be used to control bi-directional communications between the carts, the production suites of the trailer and production equipment such as cameras, enabling, for example, camera feeds to be sent to the video IO/ cart, and from the video I/O cart to the trailer, and then back to the video I/O cart (e.g., to a monitor) or through the video I/O cart to the mobile device to enable the director or other authorized user to view the processed footage, change camera views, etc. In addition, in embodiments, the production suites can be configured with wireless access points to further facilitate direct communications between the different carts and selected ones of the production suites (e.g., between the video I/O cart and the loading, DIT and VTR suites and between the audio/sound I/O cart and the audio suite). Thus, the crew can have wireless connectivity across the site.

In some embodiments, the frame of each cart can include a series of compartments in which various production components can be received, and supporting mechanisms positioned within the compartments and on which the components can be placed. In embodiments, the supporting mechanisms can include slides, drawers, or other supports that can be moveable into and out of the compartments, and which can be adapted to enable the quick change out of components and for ease of connection thereof. For example, components for recording video, audio, wireless transmission of data, playback of video, etc. can be received within the compartments, and in embodiments, can be positioned on rack-rails that can be extended from or retracted through openings in the frame to enable access to and use thereof.

Still further, in embodiments, each cart can be configured to be mobile, e.g., including wheels configured to enable the cart to be easily moved by a user, and in some embodiments, also could include a motor, such as an electric motor, to assist in moving the cart over distances and/or over more uneven terrain. Optionally, in embodiments, each cart can each include an internal power supply, such as one or more batteries, and further generally can include a power distribution component with a connection adapted to connect the cart to an external power source.

For example, in some embodiments, the carts could be linked to the tow vehicle or other nearby, on-site external power source for supplying power thereto; while, in other embodiments, one or more portable power stations and/or generators can be transported, such as by one of the transport vehicles for the production equipment and/or carts. Portable power stations can be used for many applications in place of generators to avoid the need to fuel such as gasoline, while for some, more remote filming locations, and where extended filming is required, fuel powered generators can be provided in place or in addition to portable power stations. Still further, solar charging panels can be provided for charging such portable power stations, and the power stations also can include charging ports or can be linked to charging stations for charging smaller equipment such as mobile devices for on-set communications and other, similar devices.

Optionally, it is contemplated that the power systems for each cart can include a power distribution component to distribute power between the carts and, in embodiments, enable the carts to be electrically coupled in a daisy chained arrangement to share/distribute electrical load. In embodiments, such a power distribution component can be mounted within the framework of one or more of the video I/O and sound/audio I/O carts, or can be provided as a secondary, external component such as being integrated with or coupled to a portable power station, generator or other external power source, and can be configured to couple to an external power source and provide for quick connect/disconnect connections to each of the components received within the cart for distribution of power thereto. Data line connections for transmission of data such as audio and/or video also can be provided.

In embodiments, multiple carts can be transported by the tow and/or transport vehicles, including respective video and sound carts configured to support video, and carts configured to support audio. For example, in embodiments, a plurality of video support carts and a plurality of audio support carts, can used during at least an initial stage of production at a first geographic production set location. In operation, the plurality of video support carts is operatively connected to respective camera equipment dispersed throughout the first geographic production set location and the plurality of audio support carts is operatively connected to respective sound (microphone, etc.) equipment dispersed throughout the first geographic production set location. Optionally, it is contemplated that the plurality of video support carts and the plurality of audio support carts can initially be connected in parallel and can operate as redundant systems.

In embodiments, once production has commenced, one set of production carts (comprising at least one audio support cart and at least one video support cart taken from the plurality of video support carts and the plurality of audio support carts) can be disconnected and transported to a second geographically separated set location using a transport vehicle to increase the speed and efficiency of the production by enabling the operational set-up connections of the at least one audio support cart and at least one video support cart to production equipment (cameras, microphones, lighting, etc.) positioned at the second geographically separated set location so that the second geographically separated set location can be established and readied for a next shot or sequences of scenes.

In embodiments, the designed redundancy of the carts and their operations, in cooperation with the on-site loading, digital imaging, video processing, editing, coloring, etc., and audio processing of filmed scenes provided by the mobile production command or control center/trailer facilitates the ability to provide a leapfrog filming operation, wherein filming can be started at a first site or filming location, and once filming has started (e.g., the cameras start rolling) and recorded video and audio data is being communicated between the production equipment and the carts, and thereafter to the trailer and the production suites thereof, one set of the carts (e.g., at least one video I/O cart and at least one sound/audio I/O cart) can be disconnected and transferred to a next or second filming location and communications established between the carts and the production equipment (e.g., cameras, microphones and other recording equipment, etc.) such that when the cast and filming crew arrives at the second filming location, filming can effectively start as soon as the cameras come up/are ready to roll. Thus, a director and other required on-site personnel can finish filming a scene/scenes at the first filming location and then leave that location and go to the second location, and very soon after the director and other required personnel (e.g., camera operators, actors (if needed for the next scene), etc.) arrive and the cameras come up, filming can start. In the meantime, the loading, digital imaging, copying, coloring, sound recording and other processing operations can be completed by the trailer production suites/systems in conjunction with the set of carts remaining at the first filming location. The first set of carts can then be moved to a further (e.g., a third) location, or in embodiments, to the second location, and can be set-up with production equipment moved to that next filming location, as the trailer is transferred to the second filming location and placed into communication with the carts at that location to receive and begin processing the video and audio data from that set of carts. This process can be repeated, with the carts and trailer leapfrogging from one site to the next to significantly streamline the filming production operation, helping to reduce costs, while also enabling enhanced continuity of filming of scenes (e.g., filming in sequence, which can further help reduce costs and improve efficiency, without affecting quality of the production.

In some embodiments, each cart can also include ports for chargers for recharging microphones and other wireless equipment carried by talent and crew members. In additional embodiments, each cart can include a wireless audio and an intercom system and antennas for establishing wireless connections, e.g., such as for transmission of video to the trailer and for video playback on monitors linked to the carts, and for intercom transmissions between crew members, in addition to including video monitors, wireless modems, antennas, directional microphones, and other equipment.

In embodiments, each cart can be connected directly to the trailer of the mobile production control center; while in other embodiments, wireless connections can be established between each of the parts in the one or more production suites of the trailer. For example, in embodiments, respective carts can be configured to communicate with workstations associated with a desired production suite, which can include, in embodiments and without limitation, a Digital Intermediate Technician (DIT) suite, a Video Tape Recording (VTR) suite, a sound or audio processing suite, and a Loader suite or position.

In some exemplary embodiments, the trailer can be transported and established at a filming location using the tow vehicle, which acts as a direct power source and support vehicle for the production systems of the trailer, such that the trailer can be in a powered, operating state during transport and after arriving at the filing location. Production equipment carried by the tow and/or transport vehicles can be set-up and the carts can be positioned and connected wirelessly (and, in embodiments, by direct wired connections such as for transfer of audio or sound to the audio or sound recording and processing suite of the trailer) to the production equipment and the trailer.

It is also contemplated that production equipment including one set of production carts (comprising at least one audio support cart and at least one video support cart taken from the plurality of video support carts and the plurality of audio support carts) carried by previously positioned transport vehicles can be set-up at the at the second geographically separated set location such that at least one audio support cart and at least one video support cart can be connected wirelessly (and, in embodiments, by direct wired connections such as for transfer of audio or sound to the audio or sound recording and processing suite of the trailer) to the production equipment and the trailer upon arrival at the second geographically separated set location. The second geographically separated set location can thus be established without having to set-up separate workstations for DIT, VTR, audio or sound recording and processing, and loading and copying of digital cards, which enables the second geographically separated set location to be ready for filming to start substantially immediately as soon as the production crew is ready, as well as enabling easier take-down and relocation of production equipment to a new location via use of the transport vehicle transport and set-up of production equipment at a next geographically remote filming location.

In a further exemplary embodiment, the transport vehicle can transport a plurality of video support carts and a plurality of audio support carts to be used when establishing a production set location. For example, at least two video support carts and at least two audio or sound support carts can be established for back-up as needed. Thereafter, once an initial production set location has been established, e.g., cameras, lighting, sound, etc. are set-up and at least one set of production carts has been fully engaged and operating at the initial production set location, a second set of production carts can be disconnected from the trailer and moved with additional production equipment (e.g., cameras, lighting, sound, etc.) using respective transport vehicles for set-up at other remote geographical set locations while filming continues at the current initial production set location.

In embodiments, the tow vehicle can be used to establish or set-up one or more initial production set locations, including providing power for operation of the trailer's production systems, and once filming has started, the additional set of production carts can be disconnected and loaded into the transport vehicle and moved another shooting location, to ready the next production set location for filming. In embodiments, it is contemplated that the transport vehicle can be used to act as an initial power source for such operatively coupled equipment. In some embodiments, an external power source (if available) can be established for operation of the production equipment as needed.

As a result, a next scene or series of scenes at the next production set location can be set-up, after which the tow vehicle can move the trailer to the next production set location, and since the trailer is already under power supplied by the tow vehicle, simple wired and wireless data and power connections can be established between the trailer systems and the on-site production equipment, to include the set of production carts, and filming started with minimal delay. The generated “leap-frog” effect in production of scenes at geographically remote production set locations resulting from the setting up/readying of the necessary production equipment at the next production set location. In effect, the next production set location can be pre-established to an extent such that when the trailer arrives, it can already be connected to and supplied with power from the tow vehicle such that once wireless and/or other data transfer connections are made, to include to the set of production carts, filming can start almost immediately thereafter.

In various aspects, as exemplarily shown in FIG. 6, each computer for each workstation that is associated with a plurality of production suites of the mobile production control center typically can comprise a computer or one or more processors including programming/software adapted to carry out at least the functions exemplary associated with the respective workstation. Such software may be downloaded to the processor in electronic form, over a network, for example, or it may alternatively be provided on non-transitory tangible computer-readable media, such as optical, magnetic, or electronic memory media, and the like. Alternatively or additionally, some or all of the functions of each respective computer processor may be implemented in dedicated hardware, such as a custom or semi-custom integrated circuit or a programmable digital signal processor (DSP).

Although each of the computers associated with the respective workstations for each of the plurality of production suites can be a separate unit, it is contemplated that some or all of the processing functions of the workstation computers may be performed by suitable dedicated circuitry within a host network server of the mobile production control center. Optionally, each computer can be configured as a desktop computer, a portable computer (e.g., a laptop), an all-in-one computer; or a tablet.

In an embodiment, communication with, and, in some embodiments, at least partial control of various functions associated with each of the respective workstations f the plurality of production suites can be carried out by a suitable processor that is integrated with a mobile control device having a display or with any other suitable sort of portable computerized device with a display, such as, for example and without limitation, a tablet or lap top computer. As described herein, it is contemplated that data communication between the mobile control device and the plurality of production suites can be conducted using wired communication connection protocols, wireless communication connection protocols, and a combination of wired and/or wireless communication connection protocols as desired.

In some embodiments, the display can be configured as a touchscreen comprising an electronic visual display that can detect the presence and location of a touch, typically by one or more fingers or a stylus (not shown) within the display area. When interacting with the touchscreen, user can interact directly with interactive items presented on the touchscreen, rather than indirectly via a cursor controlled by touchpad.

In aspects, it is contemplated the mobile control device allows a user, such as production director, to access, view and edit data streams associated with any of the workstations of the plurality of production suites. Referring to FIGS. 7A-7J. exemplary screen shots from the display of the mobile control illustrate example embodiments of a mobile control application operable from a mobile control device that enables communication with the production bays or production suites and control of production aspects associated with selected production suites of the mobile production control center in accordance with the principles of the present disclosure.

For example and without limitation, FIGS. 7A and 7B illustrate introduction screen for the mobile control application, with FIG. 7A exemplarily showing possible high-level production selections that identify at least the respective the plurality of production suites. FIG. 7B exemplarily shows possible mid-level production selections that identify possible VTR level inputs to include workstation selections, live and replay selections, as well as identified production personnel associate with the respective production suite. Optionally, and as shown in FIG. 7C, the selection of the DP screen in the mobile control application identifies possible mid-level production selections that identify possible VTR and/or DIT production and production selections in the mobile control application.

Similarly, FIG. 7D exemplarily shows possible lower-level production selections that identify possible cameras and QOD selection that are available in the ENG screen of the mobile control application, which is in communication with the ENG workstation. Further, FIG. 7E exemplarily shows possible lower-level production selections that identify possible lighting selections in the Lighting screen of the mobile control application, which is in communication with an associated workstation of the mobile production control center.

As contemplated and shown in FIG. 7F, a VTR screen can be selected to exemplarily show possible lower-level production selections that identify possible video production selections in the mobile control application. Similarly, if the user selects a BMD Duo Scope screen in the mobile control application as shown in FIG. 7G, a plurality of possible lower-level production selections is made available to the user. Referring to FIG. 7H, if the user selects a Leader screen in the mobile control application various optional leader related low-level production selections are presented to the user for operative interface.

It is contemplated that the user can elect to see a plurality of views in the mobile control application. In this aspect, and as exemplarily shown in FIG. 7I, the user can select a Quad Control screen to exemplarily show possible lower-level production selections that identify possible video display selections in the mobile control application. It is also contemplated that a user could interface with one or more of the DIT stations by selecting a DIT screen interface, shown in FIG. 7J, to exemplarily show possible lower-level production selections that identify possible DIT selections in the mobile control application.

The mobile control application further is configured to enable/facilitate bi-directional communication and control between the production equipment, carts and the production suites. For example, if the director wants to see different camera views, that can be controlled through the mobile control application, the application can provide a split screen of different camera views, such as a quad-split, where the director can view 4 cameras split into 4 quadrants on a mobile device or monitor on the video I/O cart, and through the mobile control application can change between different camera views (e.g., change between one of 7, 8 or more cameras). The director also can use the mobile control application to communicate with the trailer and receive processed footage therefrom. For example, the director can communicate with the VPR suite and change the cameras that are recording, or can go into the DIT suite and access the router in there and change whatever cameras that are supplying the footage being colorized. The mobile control application also can, in embodiments, be configured to communicate and/or control communication of raw and/or processed recorded video and audio data back to a studio (e.g., over a cellular network such as LTE).

In some embodiments, the mobile control application can be configured to enable the video to be routed to a mobile device such that instead of having to sit there at the cart and watch it on a cart monitor, the director or other personnel can move about the site, e.g., they wanted to move about and talk to the actors, they can pull up the video directly on the mobile device to review as needed. Thus, in embodiments, the director can direct scenes using a mobile device running the mobile control application, and can, in embodiments, do so from different mobile devices as needed. In addition, in embodiments, the director (or other authorized personnel depending on access level that enables them to access different features of the application (e.g., full control, viewing only, etc.) to communicate directly with and control, for example, the VTR suite to request and received output video from the VTR suite, for example, allowing them to request footage from different cameras, to change the cameras being used/inputting to the VTR suite, and request and change/direct what outputs can be provided therefrom.

In addition, in still other embodiments, the mobile control application can be configured to enable access to and control of other production equipment, such as accessing 3^{rd} party applications for control of other systems such as audio, etc. For example, the mobile control application can include an option or screen to interface with a control application for the Dante® audio systems used for recording and processing audio/sound such that for a set with upwards of 30, 40, 50+ actors and others on a set having wireless microphones, inputs from those not needed in a scene being filmed (which could be 1-5 actors out of the 30-50 on set) can be identified and isolated for recording just those selected wireless microphones.

The present disclosure has been described herein in terms of examples that illustrate principles and aspects of the present disclosure. The skilled artisan will understand, however, that a wide gamut of additions, deletions, alterations, and modifications, both subtle and gross, may be made to the presented examples without departing from the spirit and scope of the present disclosure. All such modifications which do not depart from the spirit of the disclosure are intended to be included within the scope of any of the aspects and/or claims provided by the present disclosure.

1. An entertainment production control system, comprising:
a tow vehicle including a power system configured to be transported therewith;
a mobile production control center comprising a plurality of production suites configured for entertainment production operations including on-site copying, digital imaging, coloring, correction and processing of video and audio data, or combinations thereof;
wherein the plurality of production suites are electrically coupled to the power system of the tow vehicle to power operations thereof;
production equipment including camera equipment; audio equipment, and lighting equipment; and
a plurality of mobile production assemblies configured to operatively communicate with at least selected ones of the production suites of the mobile production control center and with a distributed set of the production equipment positioned about a production set location; and
wherein, the entertainment production control system is configured to enable a leapfrog production operation wherein:
the mobile production control center is powered by the power system of the tow vehicle so as to perform on-site copying, digital imaging, coloring, correction and processing of video and audio data, or combinations thereof without requiring connection of the mobile production control center to shore power; and
wherein during filming and performance of production operations by the mobile production control center is on-going at a first production set location, a second set mobile production assemblies can be established at a second production set location that is remote from the first production set location and once the mobile production control center arrives at the second production set location, communication with the mobile production assemblies is initiated to begin production.

2. The entertainment production control system of claim 1, wherein the mobile production assemblies include at least one video audio support cart and at least one video support cart to a second distributed set of the production equipment that are positioned about the second production set location.

3. The entertainment production control system of claim 2, wherein the mobile production assemblies further comprises a second set of at least one video audio support cart and at least one video support cart configured to wirelessly connect to the mobile production control center upon arrival of the mobile production control center at the second production set location.

4. The entertainment production control system of claim 1, wherein the plurality of production suites comprises:
at least one least one loading position including one or more digital recording monitoring and copying systems,
at least one video recording position,
at least one digital imaging technician position, and
at least one sound recording position.

5. The entertainment production control system of claim 1, wherein the power system includes a plurality of power storage units positioned within a cargo area of the tow vehicle; and wherein the power storage units are configured to enable selective transfer of electrical power from the plurality of power storage units to the plurality of production suites and to the production equipment.

6. The entertainment production control system of claim 5, wherein the plurality of power storage units can provide electrical power for an extended duty period that is at least 12 hours.

7. The entertainment production control system of claim 5, wherein the plurality of power storage units comprises a plurality of batteries coupled to at least one invertor in a master/slave configuration.

8. The entertainment production control system of claim 1, wherein the mobile production control center comprises a trailer configured to be operatively coupled to the tow vehicle for transport to a desired production set location, wherein the trailer has a trailer body defining an enclosure in which the plurality of production suites are arranged.

9. The entertainment production control system of claim 1, wherein the power system of the tow vehicle includes at least one solar panel that is coupled to at least one inverter and to a plurality of power storage units for supplying electrical power thereto.

10. The entertainment production control system of claim 1, wherein the tow vehicle is configured to accept external power to effect charging of the power system.

11. The entertainment production control system of claim 1, further comprising a mobile control application configured with programming to enable communication with the production equipment, the production suites, and the mobile production assemblies.

12. The entertainment production control system of claim 1, wherein each mobile production assemblies is configured with an internal power supply.

13. The entertainment production control system of claim 1, wherein each mobile production assemblies is configured to connect to an external power source.

14. The entertainment production control system of claim 1, wherein each of the mobile production assemblies comprises a cart having a framework configured to support audio and/or video processing systems; and wherein the mobile production assemblies include at least one video support cart and at least one audio support cart.

15. A method of producing movies and television programs, comprising:
delivering and setting up a plurality of production equipment to a first geographic production set location, wherein the production equipment includes at least camera equipment; audio equipment, and lighting equipment;
connecting the plurality of production equipment to a plurality of mobile production assemblies, wherein the plurality of mobile production assemblies comprises a plurality of video input/output assemblies and a plurality of sound input/output assemblies that are respectively configured to receive video and audio inputs from the production equipment;
delivering a mobile production control center to the first geographic production set location via a tow vehicle including a power supply assembly configured to be transported therewith;
enabling a power transfer between the power supply assembly and the mobile production control center;
connecting the plurality of mobile production assemblies to the mobile production control center to enable transfer of video and audio data received by the mobile production assemblies from the production equipment to the mobile production control center once filming has commenced;
selecting a set of mobile production assemblies from the plurality of mobile production assemblies, wherein the set of mobile production assemblies comprises at least one video/output assembly and at least one sound input/output; and
after filming has commenced at the first geographic production set location, moving the set of the mobile production assemblies to a second geographic production set location that is remote from the first geographic production set location via at least one support vehicle.

16. The method of claim 15, further comprising delivering and setting up a second plurality of production equipment to the second geographic production set location.

17. The method of claim 16, further comprising connecting the second plurality of production equipment the mobile production assemblies.

18. The method of claim 17, further comprising connecting the mobile production assemblies to the mobile production control center upon arrival of the mobile production control center at the second geographic production set location.

19. The method of claim 15, wherein each mobile production assembly is configured as a cart.

20. The method of claim 15, further comprising establishing communication between the mobile production control center and the mobile production assemblies, and a mobile control application so as to selectively enable control of inputs into and outputs from the mobile production assemblies to a series of production suites configured for copying, coloring, editing, recording, loading, or combinations thereof, video and audio data received from the mobile production assemblies.
